(19) United States
(12) Patent Application Publication
(10) Pub. No.: US 2023/0329258 A1
(43) Pub. Date: Oct. 19, 2023

(54) METHOD FOR STERILIZING AND PRESERVING FRESH MULBERRY FRUITS

(71) Applicant: ZHEJIANG UNIVERSITY, Hangzhou (CN)

(72) Inventors: Lingxia HUANG, Hangzhou (CN); Jingyu WANG, Hangzhou (CN); Liang YANG, Hangzhou (CN); Huaqi GAO, Hangzhou (CN); Can ZHAO, Hangzhou (CN)

(21) Appl. No.: 17/793,969

(22) PCT Filed: Oct. 22, 2020
(86) PCT No.: PCT/CN2020/122788

§ 371 Date: Jun. 27, 2023

(30) Foreign Application Priority Data
Jul. 27, 2020 (CN) 202010729706. 7

(51) Int. Cl. A23B 7/015; A23B 7/04; A23B 7/152

(52) U.S. Cl. CPC A23B 7/152; A23B 7/015; A23B 7/04

(57) ABSTRACT

A method for sterilizing and preserving fresh mulberry fruits is provided. The method includes the following steps: 1) laying the fresh mulberry fruits in a single layer in a hermetic container, and 2) introducing atmospheric plasma into the hermetic container for sterilization to obtain sterilized fresh mulberry fruits. The method provided in the present disclosure can effectively inactivate bacteria, yeast, and fungi on surfaces of the mulberry fruits, such as Botrytis cinerea, Salmonella, Escherichia coli, Staphylococcus aureus, and Bacillus cereus. The method provided in the present disclosure has no significant impact on qualities of the mulberry fruit such as pH, total soluble solids (TSS), hardness, and color, and can significantly reduce rotting incidence and mildew incidence of the mulberry fruits. The rotting incidence can be reduced by up to 30.00% and the mildew incidence can be reduced by up to 25.14%.

This application claims priority to the Chinese Patent Application No. 202010729706.7, filed with the China National Intellectual Property Administration (CNIPA) on Jul. 27, 2020, and entitled “Method for Sterilizing and Preserving Fresh Mulberry Fruits”, which is incorporated herein by reference in its entirety.

### TECHNICAL FIELD

The present disclosure relates to the technical field of fruit preservation, and in particular, to a method for sterilizing and preserving fresh mulberry fruits.

### BACKGROUND ART

Sweet in taste and rich in nutrients, mulberry fruits can be used as medicine and food, are deeply loved by consumers, and have broad market development prospects. However, the mulberry fruits have only one month of maturity period, which is from May to June in the late spring and early summer, are harvested at 25-30° C., and are vulnerable to mechanical damage and microbial infection during picking. Moreover, the mulberry fruits have thin skin, soft pulp, and uneven outer surface, which provides a good base for growth of microorganisms, making the mulberry fruits very easy to rot and deteriorate, resulting in a very short shelf life. This seriously restricts the supply of the mulberry fruits and the development of the fresh fruit industry.

At present, methods for preserving fresh mulberry fruits include low-temperature storage, controlled atmosphere storage, and chemical treatment. Low-temperature storage and controlled atmosphere storage can only achieve an antibacterial effect, but cannot effectively kill pathogenic bacteria, and chemical treatment is not conducive to food safety. Therefore, there is currently a need for a safe and effective method for sterilizing and preserving fresh mulberry fruits.

### SUMMARY

An objective of the present disclosure is to provide a method for sterilizing and preserving fresh mulberry fruits, which not only is safe, but also can effectively kill pathogenic bacteria on surfaces of the fresh mulberry fruits.

To achieve the above objective of the present disclosure, the present disclosure provides the following technical solutions.

The present disclosure provides a method for sterilizing and preserving fresh mulberry fruits, including the following steps:
1) laying the fresh mulberry fruits in a single layer in a hermetic container, where the hermetic container is provided with an air inlet; and
2) introducing atmospheric plasma into the hermetic container through the air inlet for sterilization until an air pressure in the hermetic container is 101-102 kPa to obtain sterilized fresh mulberry fruits, where the atmospheric plasma has a current of 2-6 A and a temperature of 9-22° C., and the sterilization is conducted for 30-300 s.

Preferably, the atmospheric plasma may have a current of 2 A.

Preferably, the atmospheric plasma may have an introduction amount of 1-1.1 m³/min.

Preferably, the method may further include storing the sterilized fresh mulberry fruits at 1-5° C. after the sterilized fresh mulberry fruits are obtained.

Preferably, the hermetic container may have a volume of 8,000-20,000 cm³.

Preferably, the hermetic container may have specifications of length × width × height = (40-48) cm × (25-33) cm × (8-12) cm.

Preferably, the hermetic container may be further provided with an air outlet.

Preferably, the fresh mulberry fruits may be 80% ripe, plump, and purple black.

Beneficial effects of the present disclosure: the present disclosure provides a method for sterilizing and preserving fresh mulberry fruits, including the following steps: 1) laying the fresh mulberry fruits in a single layer in a hermetic container, and 2) introducing atmospheric plasma into the hermetic container for sterilization to obtain sterilized fresh mulberry fruits. The method provided in the present disclosure can effectively inactivate bacteria, yeast, and fungi on surfaces of the mulberry fruits, such as Botrytis cinerea, Salmonella, Escherichia coli, Staphylococcus aureus, and Bacillus cereus. A total number of bacteria can be reduced by up to 3.65 log CFU/g. A total number of yeast and mold can be reduced by up to 1.59 log CFU/g. A total number of Escherichia coli can be reduced by up to 2.56 log CFU/g. A total number of Staphylococcus aureus can be reduced by up to 2.77 log CFU/g. A total number of Bacillus cereus can be reduced by up to 3.98 log CFU/g. The method provided in the present disclosure has no significant impact on qualities of the mulberry fruit such as pH, total soluble solids (TSS), hardness, and color, and can significantly reduce rotting incidence and mildew incidence of the mulberry fruits. The rotting incidence can be reduced by up to 30.00% and the mildew incidence can be reduced by up to 25.14%.

### BRIEF DESCRIPTION OF THE DRAWINGS

FIG. 1 is a system construction frame diagram of atmospheric low-temperature plasma;

FIG. 2 is an external structure diagram of an atmospheric plasma generator;

FIG. 3 is an internal structure diagram of the atmospheric plasma generator;

FIG. 4 shows an atmospheric low-temperature plasma power supply;

FIG. 5 shows a vortex jet;

FIG. 6 shows a hermetic container;

FIG. 7 shows changes in total number of bacteria in mulberry fruits during storage;

FIG. 8 shows changes in total number of yeast and mold in the mulberry fruits during storage;

FIG. 9 shows changes in total number of Escherichia coli in the mulberry fruits during storage;

FIG. 10 shows changes in total number of Staphylococcus aureus in the mulberry fruits during storage;

FIG. 11 shows changes in total number of Bacillus cereus in the mulberry fruits during storage;

FIG. 12 shows an optical density (OD)-culture time standard curve of Salmonella;

FIG. 13 shows an OD-bacterial count standard curve of Salmonella;

FIG. 14A shows number of colonies of Salmonella in the mulberry fruits generated by different parameter settings after atmospheric plasma treatment;

FIG. 14B shows number of colonies of Salmonella in the mulberry fruits on the day of treatment;

FIG. 14C shows number of colonies of Salmonella in the mulberry fruits on the 2^{nd} day of storage;

FIG. 14D shows number of colonies of Salmonella in the mulberry fruits on the 4^{th} day of storage;

FIG. 14E shows number of colonies of Salmonella in the mulberry fruits on the 8^{th} day of storage;

FIG. 14F shows colony changes of Salmonella in the mulberry fruits after atmospheric plasma treatment under different conditions during storage;

FIG. 15A shows red-green colors (a*) of the mulberry fruits after atmospheric plasma treatment under different conditions;

FIG. 15B shows yellow-blue colors (b*) of the mulberry fruits after atmospheric plasma treatment under different conditions;

FIG. 15C shows brightness (L*) of the mulberry fruits after atmospheric plasma treatment under different conditions;

FIG. 16 shows hardness of the mulberry fruits after atmospheric plasma treatment under different conditions;

FIG. 17 shows pH of the mulberry fruits after atmospheric plasma treatment under different conditions;

FIG. 18 shows TSS of the mulberry fruits after atmospheric plasma treatment under different conditions;

FIG. 19 shows a rotting incidence of the mulberry fruits during storage at 20° C. after atmospheric plasma treatment; and

FIG. 20 shows a mildew incidence of the mulberry fruits during storage at 20° C. after atmospheric plasma treatment.

### DETAILED DESCRIPTION OF THE EMBODIMENTS

The present disclosure provides a method for sterilizing and preserving fresh mulberry fruits, including the following steps.

1) The fresh mulberry fruits are laid in a single layer in a hermetic container. The hermetic container is provided with an air inlet.

2) Atmospheric plasma is introduced into the hermetic container through the air inlet for sterilization until an air pressure in the hermetic container is 101-102 kPa to obtain sterilized fresh mulberry fruits. The atmospheric plasma has a current of 2-6 A, preferably 3-5 A, and a temperature of 9-22° C., preferably 20° C., and the sterilization is conducted for 30-300 s, preferably 50-250 s, and more preferably, 100-150 s.

According to the present disclosure, the fresh mulberry fruits are laid in a single layer in the hermetic container. The hermetic container is provided with the air inlet. The air inlet has specifications of preferably 29-31 mm. The fresh mulberry fruits are preferably 80% ripe, preferably purple black, and plump, and are sterilized and preserved on the day of picking. The varieties of the fresh mulberry fruits preferably include Big 10 (or called Big Ten, Seedless Big Ten, and Seedless Big 10). The fresh mulberry fruits are preferably intact fresh mulberry fruits with uniform size, consistent color and maturity, and no mechanical damage. The fresh mulberry fruits have a weight of preferably 5.0±0.50 g/piece. The fresh mulberry fruits of the present disclosure come from conventional commercial sources. In the specific implementation process of the present disclosure, the fresh mulberry fruits are picked from the mulberry resources nursery of the Zijingang campus of Zhejiang University.

In the present disclosure, the hermetic container is preferably further provided with an air outlet. The air outlet has specifications of preferably 29-31 mm. The hermetic container has a volume of preferably 8,000-20,000 cm³, more preferably 10,000-18,000 cm³, and most preferably 15,000 cm³. The hermetic container has specifications of preferably length×width×height=(40-48) cm×(25-33) cm×(8-12) cm, more preferably length×width×height=45.6 cm×29.6 cm×11.2 cm. The hermetic container preferably includes an airtight container. In the specific implementation process of the present disclosure, an airtight container (HPL894) is used as the hermetic container with a size of 45.6 cm×29.6 cm×11.2 cm. Both ends of the airtight container are provided with two circular holes with an inner diameter of preferably 30 mm. A metal connecting sleeve is installed at the circular holes in combination with gaskets and nuts to be used as an air inlet and an air outlet. The air inlet includes one end connected with an air outlet chamber of an atmospheric plasma reactor through the sleeve of a polyvinyl chloride (PVC) tube, and the other end being an atmospheric plasma outlet.

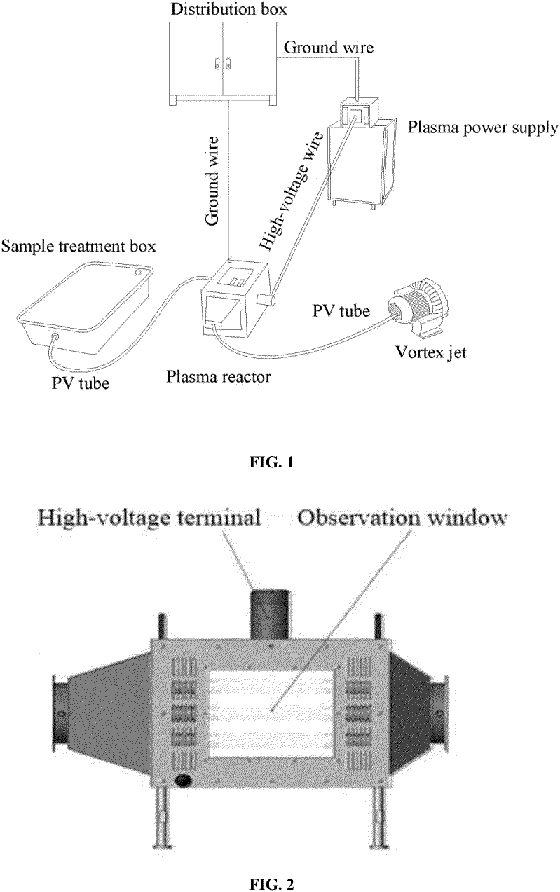

In the specific implementation process of the present disclosure, the method for sterilizing and preserving fresh mulberry fruits is based on an atmospheric dielectric barrier discharge plasma system (which is as shown in FIG. 1, and FIG. 1 is a system construction frame diagram of atmospheric low-temperature plasma). The atmospheric dielectric barrier discharge plasma system includes a distribution box, an atmospheric plasma power supply, an atmospheric plasma discharge reactor, a vortex jet, an airtight container, a PVC tube, a ground wire, and a high-voltage wire. In the present disclosure, the distribution box and the atmospheric plasma power supply are electrically connected through the ground wire. The atmospheric plasma power supply and the atmospheric plasma discharge reactor are electrically connected through the high-voltage wire. The distribution box and the atmospheric plasma discharge reactor are electrically connected through the ground wire. In the present disclosure, an air jet hole of the vortex jet and an air inlet of the atmospheric plasma discharge reactor are connected by the PVC tube. An air outlet of the atmospheric plasma discharge reactor and an air inlet of the airtight container are connected by the PVC tube.

In the present disclosure, the atmospheric plasma power supply, the atmospheric plasma discharge reactor, the vortex jet, the airtight container, the PVC tube, the ground wire, and the high-voltage wire are available from conventional commercial sources.

In the present disclosure, atmospheric plasma is introduced into the hermetic container through the air inlet of the hermetic container for sterilization until an air pressure in the hermetic container is 101-102 kPa to obtain sterilized fresh mulberry fruits. The atmospheric plasma has a current of 2-6 A and a temperature of 9-22° C., and the sterilization is conducted for 30-300 s, preferably 300 s. In the specific implementation process of the present disclosure, after atmospheric plasma is introduced into the hermetic container until an air pressure in the hermetic container is 101-102 kPa, the method further includes sealing the air outlet with a sealing film, so as to prevent the atmospheric plasma from leaking. In the present disclosure, the atmospheric plasma has a current of preferably 2 A. The atmospheric plasma has an introduction amount of preferably 1-1.1 m³/min, more preferably 1.05 m³/min.

After the sterilized fresh mulberry fruits are obtained, the present disclosure further includes storing the sterilized fresh mulberry fruits at preferably 1-5° C., more preferably 4° C.

The technical solutions in the present disclosure are clearly and completely described below in conjunction with examples of the present disclosure. It is clear that the described examples are merely a part, rather than all of the examples of the present disclosure. All other examples obtained by those of ordinary skill in the art based on the examples of the present disclosure without creative efforts shall fall within the protection scope of the present disclosure.

The device used in the present example was an atmospheric dielectric barrier discharge plasma system, including an atmospheric plasma power supply, an atmospheric plasma discharge reactor, a vortex jet, an airtight container, a PVC tube, a high-voltage wire, and a ground wire. The system construction frame diagram of atmospheric low-temperature plasma is shown in FIG. 1.

### 1) Reactor

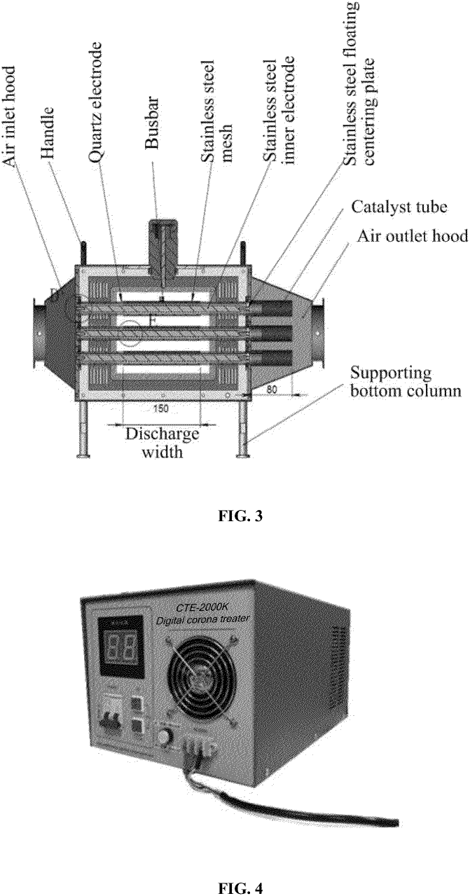

The atmospheric plasma reactor was a single dielectric 9-tube discharge reactor, purchased from Nanjing Suman Plasma Technology Co., Ltd. The materials of the reactor were all made of stainless steel and polytetrafluoroethylene. An external structure included a high-voltage terminal, a grounding terminal, an observation window, and a handle. The high-voltage terminal was connected with a high-voltage terminal of the power supply through the high-voltage wire. The grounding terminal was connected with the distribution box through the ground wire. Reference may be made to FIG. 2 for details. FIG. 2 is an external structural diagram of an atmospheric plasma generator. An internal structure included: a quartz electrode, abusbar, a stainless steel mesh, a stainless steel electrode, a stainless steel floating centering plate, a catalyst tube, an air inlet hood, and an air outlet hood. Its internal structure is shown in FIG. 3. FIG. 3 is an internal structure diagram of the atmospheric plasma generator.

The plasma was generated between parallel electrodes with a discharge width of 150 mm and a unilateral discharge gap of 3 mm. An outer electrode was a quartz tube with an outer diameter of Ø25 and an inner diameter of Ø20. An inner electrode was a toothed stainless steel electrode with a groove diameter of Ø11 and a boss diameter of Ø14. A hole on the right side of the chamber was used for air intake, and a hole on the left end was used for air exhaust. There were glass windows at both ends before and after the discharge for observation of discharge and spectral diagnosis. A working gas used in this research was all air, which was connected with the discharge chamber after passing through the PVC tube through the vortex jet device built in the laboratory.

### 2) Atmospheric Plasma Power Supply

A digital corona treatment power supply (CTE-2000K) was used, as shown in FIG. 4. FIG. 4 shows an atmospheric low-temperature plasma power supply. The power supply was provided with a high-voltage terminal and a grounding terminal on one side and a control console on the other side, which could switch a power supply mode of the single dielectric 9-tube reactor or a liquid reactor, and could also control the current. The treatment current was adjusted by pressing the button in a range of 1-6 A. The power supply connection voltage was AC 220 V and the power was 1,500 VA.

### 3) Vortex Jet

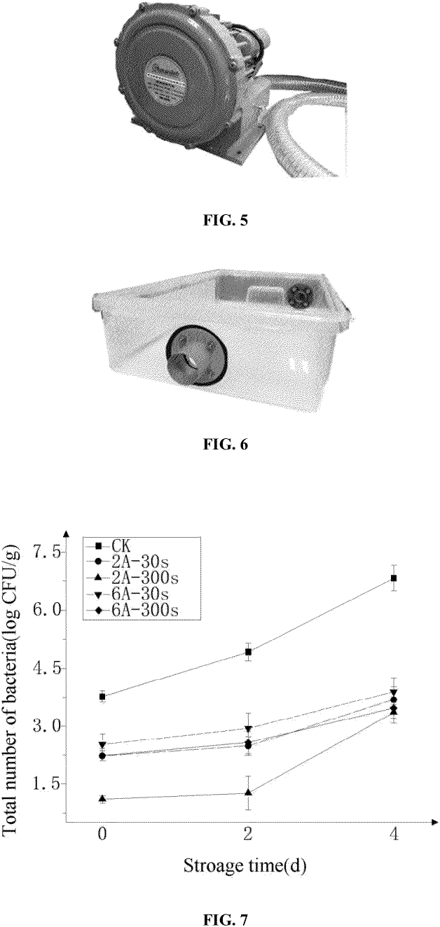

The model of the vortex jet was SM-290, as shown in FIG. 5. FIG. 5 shows the vortex jet. The vortex jet was connected with the plasma reactor through the PVC tube to pump the atmosphere into the reactor discharge chamber. The voltage was 220 V/50 Hz. The air pressure was 1,150 mmH₂O. The power was 290 W. The rotation speed was: 2,900 r/min. The exhaust volume was 1.05 m³/min.

### 4) Hermetic Container

The airtight container (HPL894) was used as the hermetic container with a size of 456×296×112 mm, as shown in FIG. 6. FIG. 6 shows the hermetic container. Two circular holes with an inner diameter of 30 mm were drilled at both ends of the airtight container, and a metal connecting sleeve was installed at the circular holes in combination with gaskets and nuts to be used as an air inlet and an air outlet. The air inlet included one end connected with the air outlet chamber of the atmospheric plasma reactor through the sleeve of the PVC tube, and the other end being the atmospheric plasma outlet.

### Example 1

### 1. Materials

1) Mulberry fruits: The mulberry fruits were picked from the mulberry resources nursery of the Zijingang campus of Zhejiang University. The variety was Big 10 (or called Big Ten, Seedless Big Ten, and Seedless Big 10). The fresh mulberry fruits were 80% ripe, plump, and purple black.

### 2) Preparation of Main Media and Reagents:

A plate count agar (PCA) medium was purchased from Beijing Land Bridge Biotechnology Co., Ltd. 23.5 g of the PCA medium was weighed using an electronic balance and placed into a conical flask, added with 1,000 mL of distilled water, heated and stirred to dissolve, sterilized under high pressure at 121° C. for 15 min, cooled to 46° C. at a room temperature, sub-packed into sterilized petri dishes, solidified naturally, and stored at 4° C. for later use.

A potato dextrose agar (PDA) medium was purchased from Beijing Land Bridge Biotechnology Co., Ltd. 40.1 g of the PDA medium was weighed with an electronic balance and placed into a conical flask, 1,000 mL of distilled water was added, heated and stirred to dissolve, sterilized under high pressure at 121° C. for 15 min, cooled to 50-60° C. at a room temperature, sub-packed into sterilized petri dishes, solidified naturally, and stored at 4° C. for later use.

An eosin methylene blue agar (EMB) medium was purchased from Beijing Land Bridge Biotechnology Co., Ltd. 37.5 g of the EMB medium was weighed with an electronic balance and placed into a conical flask, 1,000 mL of distilled water was added, heated and stirred to dissolve, sterilized under high pressure at 121° C. for 15 min, cooled to 50-60° C. at a room temperature, sub-packed into sterilized petri dishes, solidified naturally, and stored at 4° C. for later use.

A mannitol egg yolk polymyxin (MEYP) agar medium was purchased from Beijing Land Bridge Biotechnology Co., Ltd. 46.1 g of the MEYP agar medium was weighed with an electronic balance and placed into a conical flask, 950 mL of distilled water was added, heated and stirred to dissolve, sterilized under high pressure at 121° C. for 15 min, cooled to 55° C. at a room temperature, added with 5 mL of 50% egg yolk solution and one bottle of P-3E polymyxin B solution (10,000 IU) per 95 mL, poured into the plate after mixing, solidified naturally, and stored at 4° C. for later use.

A Baird-Parker agar (BPA) medium was purchased from Beijing Land Bridge Biotechnology Co., Ltd. 63 g of the BPA medium was weighed with an electronic balance and placed into a conical flask, 950 mL of distilled water was added, heated and stirred to dissolve, sterilized under high pressure at 121° C. for 15 min, cooled to 55° C. at a room temperature, 5 mL of 50% potassium tellurite egg yolk enrichment solution and 95 mL of Baird-Parker agar J (BPA J) medium per 95 mL were added, poured into the plate after mixing, solidified naturally, and stored at 4° C. for later use.

A xylose lysine sodium deoxycholate medium was purchased from Beijing Land Bridge Biotechnology Co., Ltd. 58.9 g of the xylose lysine sodium deoxycholate medium was weighed with an accurate electronic balance and placed into a conical flask, 1,000 mL of distilled water was added, stirred evenly with a glass rod, heated to boil, cooled to 50-60° C. at a room temperature, sub-packed into sterilized petri dishes, subjected to still standing for a while to solidify naturally, and stored in a 4° C. refrigerator for later use.

0.85 g of analytically pure sodium chloride (NaCl) was weighed with an electronic balance and placed into a conical flask, 99.15 mL of distilled water was added, heated and stirred to dissolve, put into an autoclave for high-pressure sterilization at 121° C. for 15 min, and stored at a low temperature of 4° C. for later use, that was, sterile saline with a concentration of 0.85%.

### 2. Method

### 1) Preparation of Mulberry Fruits

6 intact fresh mulberry fruits of Big 10 (or called Big Ten, Seedless Big Ten, and Seedless Big 10) varieties with uniform size, consistent color and maturity, and no mechanical damage were selected, and divided into 3 groups. The fresh mulberry fruits had a weight controlled at 5.0±0.50 g/piece for later use.

### 2) Atmospheric Plasma Sterilization Treatment

4 experimental groups and 1 CK group were used. The blank control without any treatment was used as the CK group, and the atmospheric plasma treatment group was used as the experimental group. The experimental group was treated with a current of 2 A for 300 s, and the control group was treated with a current of 6 A for 30 s. Three duplicates were set for each group, and the experiment was repeated twice.

### 3) Preparation of Sample Stock Solution

The sterilized mulberry fruits were put into the ultra-clean workbench. The mulberry fruit sample (about 10 g) was taken out aseptically, put into a sterilized conical flask containing 90 mL of 0.85% sterile saline solution, and shaken for 3 min with a vortexer to prepare a 1:10 sample stock solution. The stock solution was diluted step by step according to a 10-fold gradient, and diluted to the appropriate 3 degrees of dilution for later use (the degree ofdilution used to detect each different bacteria was selected according to the original bacterial count).

### 4) Determination of Total Number of Bacteria

0.1 mL of the sample dilution was pipetted onto the PCA medium, spread evenly on the PCA plate with a disposable coating rod, and put in a 37° C. biochemical incubator for culture for 24-48 h to determine the total number of bacterial colonies. After plasma sterilization treatment, microbial indexes were detected immediately once every 48 h. The measurement results are shown in Table 1 and FIG. 7. FIG. 7 shows changes in the total number of bacteria in the mulberry fruits during storage.

TABLE 1

Total number of bacteria in mulberry fruits during storage at 20° C. after atmospheric plasma treatment

| | | | |
|---|---|---|---|
| Treatment | 0 d | 2 d | 4 d |
| CK | 3.76±0.15a | 4.92±0.24a | 6.82±0.34a |
| 2A-30 s | 2.26±0.15c | 2.49±0.24c | 3.68±0.34c |
| 2A-300 s | 1.1±0.10d | 1.27±0.44d | 3.36±0.29d |
| 6A-30 s | 2.53±0.27b | 2.95±0.39b | 3.90±0.35b |
| 6A-300 s | 2.23±0.13c | 2.57±0.29c | 3.46±0.25d |

Note: Different letters after values in the same column indicate significant differences (p<0.05)

It can be seen from Table 1 that on the day of treatment, the total number of bacteria in the atmospheric low-temperature plasma treatment groups was significantly less than that in the CK group, and there were significant differences. Compared with the CK group, the 2A-30 s, 2A-300 s, 6A-30 s, and 6A-300 satmospheric plasma treatment groups could inhibit 1.50 log CFU/g, 2.66 log CFU/g, 1.23 log CFU/g, and 1.53 log CFU/g of bacteria.

On the 2^{nd} day of storage at 20° C. after treatment, the total number of bacteria in the atmospheric plasma treatment groups was significantly less than that in the CK group, and there were significant differences. Compared with the control group, the 2A-30 s, 2A-300 s, 6A-30 s, and 6A-300 s atmospheric plasma treatment groups could inhibit 2.43 log CFU/g, 3.65 log CFU/g, 1.97 log CFU/g, and 2.35 log CFU/g of bacteria respectively.

On the 4^{th} day of storage at 20° C., the total number of bacteria in the atmospheric plasma treatment groups was significantly less than that in the CK group, and there were significant differences. Compared with the control group, the 2A-30 s, 2A-300 s, 6A-30 s, and 6A-300 s atmospheric plasma treatment groups could inhibit 3.14 log CFU/g, 3.46 log CFU/g, 2.92 log CFU/g, and 3.36 log CFU/g of bacteria respectively.

It can be seen from FIG. 7 that during storage from day 0 to day 2, the total number of bacteria in the CK group increased by 1.16 log CFU/g. The total number of bacteria in the 2A-30 s treatment group increased by 0.23 log CFU/g. The total number of bacteria in the 2A-300 s treatment group increased by 0.17 log CFU/g. The total number of bacteria in the 6A-30 s treatment group increased by 0.42 log CFU/g. The total number of bacteria in the 6A-300 s treatment group increased by 0.34 log CFU/g. The total number of bacteria in the CK group had the largest increase and the highest growth rate. Although the total number of bacteria in the plasma treatment groups also increased, the increase was smaller, and the 2A-300 s treatment group had the smallest increase in the total number of bacteria. It is showed that atmospheric plasma had an antibacterial effect during this storage period, and could inhibit the increase of the total number of bacteria.

During storage from day 2 to day 4, the total number of bacteria in the CK group increased by 1.90 log CFU/g. The total number of bacteria in the 2A-30 s treatment group increased by 1.19 log CFU/g. The total number of bacteria in the 2A-300 s treatment group increased by 2.09 log CFU/g. The total number of bacteria in the 6A-30 s treatment group increased by 0.95 log CFU/g. The total number of bacteria in the 6A-300 s treatment group increased by 0.89 log CFU/g. Although the 2A-300 s treatment group had the largest relative increase in the total number of bacteria, its colony number on the 4^{th} day was still the smallest among all groups, and the colony number in the CK group was still the largest. It is showed that atmospheric plasma still had a certain antibacterial effect during this storage period, and could inhibit the increase of the total number of bacteria.

From the day of treatment till the end of storage, the total number of bacteria in the CK group increased by 3.06 log CFU/g. The total number of bacteria in the 2A-30 s treatment group increased by 1.42 log CFU/g. The total number of bacteria in the 2A-300 s treatment group increased by 2.26 log CFU/g. The total number of bacteria in the 6A-30 s treatment group increased by 1.37 log CFU/g. The total number of bacteria in the 6A-300 s treatment group increased by 1.23 log CFU/g. The increase in the total number of bacteria in the plasma treatment groups was less than that in the CK group. No matter on day 0, day 2 or day 4, the total number of bacteria in the plasma treatment groups was less than that in the CK group. The total number of bacteria in the 2A-300 s treatment group was always the smallest in the treatment groups, indicating that the 2A-300 s plasma treatment had the optimal inhibitory effect on the bacteria.

### 5) Determination of Total Number of Yeast and Mold Colonies

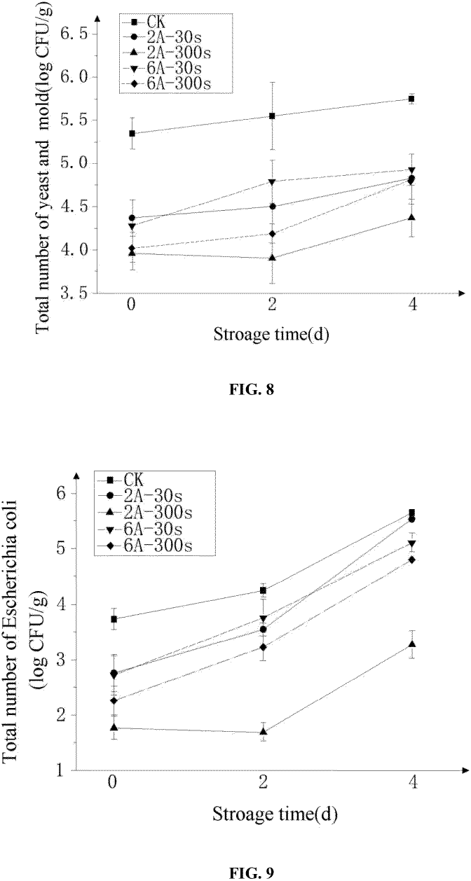

0.1 mL of the sample dilution was pipetted onto the PDA medium, spread evenly on the PDA plate with a disposable coating rod, and put in a 28° C. biochemical incubator for culture for 5-7 d to determine the total number of yeast and mold colonies. The detection was conducted once every 48 h. The detection results are shown in Table 2 and FIG. 8. FIG. 8 shows changes in the total number of yeast and mold in the mulberry fruits during storage.

TABLE 2

Total number of yeast and mold in mulberry fruits during storage at 20° C. after atmospheric plasma treatment

| | | | |
|---|---|---|---|
| Treatment | 0 d | 2 d | 4 d |
| CK | 5.35±0.18a | 5.55±0.39a | 5.75±0.34a |
| 2A-30 s | 4.37±0.21b | 4.5±0.28c | 4.83±0.09b |
| 2A-300 s | 3.96±0.10c | 3.91±0.30e | 4.37±0.22c |
| 6A-30 s | 4.28±0.08b | 4.79±0.25b | 4.93±0.18b |
| 6A-300 s | 4.03±0.26c | 4.19±0.11d | 4.82±0.29b |

Note: Different letters after values in the same column in the table indicate significant differences, p<0.05

It can be seen from Table 2 that on the day of treatment, the total number of yeast and mold in the atmospheric plasma treatment groups was significantly less than that in the CK group, and there were significant differences. The 2A-30 s, 2A-300 s, 6A-30 s, and 6A-300 s atmospheric plasma treatment groups could inhibit 0.98 log CFU/g, 1.39 log CFU/g, 1.07 log CFU/g, and 1.32 log CFU/g of yeast and mold respectively.

On the 2^{nd} day of storage at 20° C. after treatment, the total number of yeast and mold in the atmospheric plasma treatment groups was significantly less than that in the CK group, and there were significant differences. The 2A-30 s, 2A-300 s, 6A-30 s, and 6A-300 s atmospheric plasma treatment groups could inhibit 1.05 log CFU/g, 1.64 log CFU/g, 0.76 log CFU/g, and 1.36 log CFU/g of yeast and mold respectively.

On the 4^{th} day of storage at 20° C. after treatment, the total number of yeast and mold in the atmospheric plasma treatment groups was significantly less than that in the CK group, and there were significant differences. The 2A-30 s, 2A-300 s, 6A-30 s, and 6A-300 s atmospheric plasma treatment groups could inhibit 0.92 log CFU/g, 1.38 log CFU/g, 0.82 log CFU/g, and 0.93 log CFU/g of yeast and mold respectively.

It can be seen from FIG. 8 that during storage from day 0 to day 2, the total number of yeast and mold in the CK group, the 2A-30 s treatment group, the 6A-30 s treatment group, and the 6A-300 s treatment group increased by 0.20 log CFU/g, 0.13 log CFU/g, 0.51 log CFU/g, and 0.16 log CFU/g respectively, and the total number of yeast and mold in the 2A-300 s treatment group decreased by 0.05 log CFU/g. The total number of yeast and mold in the 6A-30 s group had the largest increase. The total number of yeast and mold in the 2A-300 s group did not increase but decreased, and the total number of yeast and mold in the other groups increased. At the storage point on day 2, the CK group still had the largest total number of yeast and mold. It is showed that atmospheric plasma had an antibacterial effect during this storage period, and could inhibit the increase of the total number of yeast and mold.

During storage from day 2 to day 4, the total number of yeast and mold in all the groups increased. The total number of yeast and mold in the CK group increased by 0.2 log CFU/g. The total number of yeast and mold in the 2A-30 s, 2A-300 s, 6A-30 s, and 6A-300 s atmospheric plasma treatment groups increased by 0.33 log CFU/g, 0.46 log CFU/g, 0.14 log CFU/g, and 0.63 log CFU/g respectively. The total number of yeast and mold after plasma growth was still less than that of the CK group, that is, the CK group still had the largest total number of yeast and mold.

From the day of treatment till the end of storage, the total number of yeast and mold in the CK group increased by 0.40 log CFU/g. The total number of yeast and mold in the 2A-30 s treatment group increased by 0.46 log CFU/g. The total number of yeast and mold in the 2A-300 s treatment group increased by 0.41 log CFU/g. The total number of yeast and mold in the 6A-30 s treatment group increased by 0.65 log CFU/g. The total number of yeast and mold in the 6A-300 s treatment group increased by 0.79 log CFU/g. Although the increase in the total number of yeast and mold in the plasma treatment groups was slightly greater than that in the CK group, the total number of yeast and mold in the CK group was greater than that in the plasma treatment groups throughout the storage period, and there were significant differences. No matter on day 0, day 2 or day 4, the 2A-300 s treatment group had the optimal inhibitory effect on the total number of yeast and mold.

### 6) Determination of Total Number of Escherichia Coli Colonies

0.1 mL of the sample dilution was pipetted onto the EMB medium, spread evenly on the EMB plate with a disposable coating rod, and put in a biochemical incubator for culture at 37° C. for 24-48 h to determine the total number of Escherichia coli colonies. The detection was conducted once every 48 h. The detection results are shown in Table 3 and FIG. 9. FIG. 9 shows changes in the total number of Escherichia coli in the mulberry fruits during storage.

TABLE 3

Total number of Escherichia coli in mulberry fruits during storage at 20° C. after atmospheric plasma treatment

| | | | |
|---|---|---|---|
| Treatment | 0 d | 2 d | 4 d |
| CK | 3.73±0.19a | 4.25±0.12a | 5.65±0.04a |
| 2A-30 s | 2.76±0.33b | 3.54±0.12c | 5.54±0.05a |
| 2A-300 s | 1.77±0.21d | 1.69±0.17e | 3.27±0.25d |
| 6A-30 s | 2.72±0.35b | 3.75±0.33b | 5.11±0.17b |
| 6A-300 s | 2.26±0.26c | 3.23±0.26d | 4.81±0.08c |

Note: Different letters after values in the same column in the table indicate significant differences, p<0.05

It can be seen from Table 3 that on the day of treatment, the total number of Escherichia coli in the atmospheric plasma treatment groups was significantly less than that in the CK group, and there were significant differences. The 2A-30 s, 2A-300 s, 6A-30 s, and 6A-300 s atmospheric plasma treatment groups could inhibit 0.97 log CFU/g, 1.96 log CFU/g, 1.01 log CFU/g, and 1.47 log CFU/g of Escherichia coli respectively.

On the 2^{nd} day of storage at 20° C. after treatment, the total number of Escherichia coli in the atmospheric plasma treatment groups was significantly less than that in the CK group, and there were significant differences. The 2A-30 s, 2A-300 s, 6A-30 s, and 6A-300 s atmospheric plasma treatment groups could inhibit 0.71 log CFU/g, 2.56 log CFU/g, 0.50 log CFU/g, and 1.02 log CFU/g of Escherichia coli respectively.

On the 4^{th} day of storage at 20° C. after treatment, the total number of Escherichia coli in the atmospheric plasma treatment groups was significantly less than that in the CK group, there was no significant difference between the 2A-30 s treatment groups and the CK group, and there were significant differences among the other groups. The 2A-300 s, 6A-30 s, and 6A-300 s atmospheric plasma treatment groups could inhibit 2.38 log CFU/g, 0.54 log CFU/g, and 0.84 log CFU/g of Escherichia coli respectively.

It can be seen from FIG. 9 that during storage from day 0 to day 2, the total number of Escherichia coli in the CK group, the 2A-30 s treatment group, the 6A-30 s treatment group, and the 6A-300 s treatment group increased by 0.52 log CFU/g, 0.78 log CFU/g, 1.03 log CFU/g, and 0.97 log CFU/g respectively, and the total number of Escherichia coli in the 2A-300 s treatment group decreased by 0.08 log CFU/g. The CK group still had the largest total number of Escherichia coli. It is showed that atmospheric plasma had an antibacterial effect during this storage period, and could inhibit the increase of the total number of Escherichia coli.

During storage from day 2 to day 4, the total number of Escherichia coli in all the groups increased significantly. The total number of Escherichia coli in the CK group increased by 1.40 log CFU/g. The total number of Escherichia coli in the 2A-30 s, 2A-300 s, 6A-30 s, and 6A-300 s atmospheric plasma treatment groups increased by 2.00 log CFU/g, 1.58 log CFU/g, 1.36 log CFU/g, and 1.58 log CFU/g respectively. The CK group still had the largest total number of Escherichia coli.

From the day of treatment till the end of storage, the total number of Escherichia coli in the CK group increased by 1.92 log CFU/g. The total number of Escherichia coli in the 2A-30 s, 2A-300 s, 6A-30 s, and 6A-300 s atmospheric plasma treatment groups increased by 2.78 log CFU/g, 1.50 log CFU/g, 2.39 log CFU/g, and 2.55 log CFU/g respectively. The increase in the total number of Escherichia coli in the plasma treatment groups was slightly greater than that in the CK group, but the total number of Escherichia coli in the plasma treatment groups was less than that in the CK group. No matter on day 0, day 2 or day 4, the 2A-300 s treatment group had the optimal inhibitory effect on the total number of Escherichia coli.

### 7) Determination of Total Number of Staphylococcus Aureus Colonies

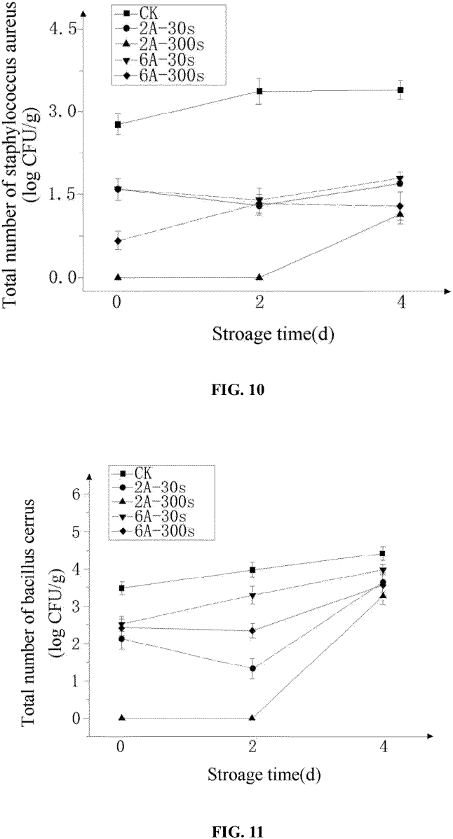

0.1 mL of the sample dilution was pipetted onto the BPA medium, spread evenly on the BPA plate with a disposable coating rod, and put in a biochemical incubator for culture at 37° C. for 24-48 h to determine the total number of Staphylococcus aureus colonies. The detection was conducted once every 48 h. The measurement results are shown in Table 4 and FIG. 10. FIG. 10 shows changes in the total number of Staphylococcus aureus in the mulberry fruits during storage.

TABLE 4

Impact of atmospheric plasma treatment on total number of Staphylococcus aureus in mulberry fruits during storage at 20° C.

| | | | |
|---|---|---|---|
| Treatment | 0 d | 2 d | 4 d |
| CK | 2.17±0.19a | 3.37±0.24a | 3.40±0.17a |
| 2A-30 s | 1.59±0.20b | 1.29±0.16b | 1.70±0.00b |
| 2A-300 s | 0.00±0.00d | 0.00±0.00c | 1.13±0.17c |
| 6A-30 s | 1.59±0.20b | 1.39±0.23b | 1.80±0.10b |
| 6A-300 s | 0.67±0.17c | 1.33±0.17b | 1.29±0.26c |

Note: Different letters after values in the same column in the table indicate significant differences, p<0.05

It can be seen from Table 4 that on the day of treatment, the total number of Staphylococcus aureus in the atmospheric plasma treatment groups was significantly less than that in the CK group. The 2A-30 s, 2A-300 s, 6A-30 s, and 6A-300 s atmospheric plasma treatment groups could inhibit 0.58 log CFU/g, 2.17 log CFU/g, 0.58 log CFU/g, and 1.5 log CFU/g of Staphylococcus aureus respectively.

On the 2^{nd} day of storage at 20° C. after treatment, the total number of Staphylococcus aureus in the atmospheric plasma treatment groups was significantly less than that in the CK group. The 2A-30 s, 2A-300 s, 6A-30 s, and 6A-300 s atmospheric plasma treatment groups could inhibit 2.08 log CFU/g, 3.37 log CFU/g, 1.98 log CFU/g, and 2.04 log CFU/g of Staphylococcus aureus respectively.

On the 4^{th} day of storage at 20° C. after treatment, the total number of Staphylococcus aureus in the atmospheric plasma treatment groups was significantly less than that in the CK group, and there were significant differences. The 2A-30 s treatment group could inhibit 1.70 log CFU/g of Staphylococcus aureus. The 2A-300 s treatment group could inhibit 2.27 log CFU/g of Staphylococcus aureus. The 6A-30 s treatment group could inhibit 1.60 log CFU/g of Staphylococcus aureus. The 6A-300 s treatment group could inhibit 2.11 log CFU/g of Staphylococcus aureus.

It can be seen from FIG. 10 that during storage from day 0 to day 2, the total number of Staphylococcus aureus in the CK group increased by 1.2 log CFU/g. The total number of Staphylococcus aureus in the 2A-30 s treatment group decreased by 0.30 log CFU/g. There was no change in the 2A-300 s treatment group, both below a detection level. The total number of Staphylococcus aureus in the 6A-30 s treatment group decreased by 0.20 log CFU/g. The total number of Staphylococcus aureus in the 6A-300 s treatment group increased by 0.66 log CFU/g. The total number of Staphylococcus aureus in the 6A-300 s group had the largest increase. The total number of Staphylococcus aureus in the 2A-30 s and 6A-30 s treatment groups did not increase but decreased. No Staphylococcus aureus was detected in the 2A-300 s group during this storage period. At the storage point on day 2, the CK group still had the largest total number of Staphylococcus aureus, which was much greater than that in the plasma treatment groups. It is showed that atmospheric plasma had an antibacterial effect during this storage period, and could inhibit the increase of the total number of Staphylococcus aureus.

During storage from day 2 to day 4, the total number of Staphylococcus aureus in all the groups increased significantly. The total number of Staphylococcus aureus in the CK group increased by 0.03 log CFU/g. The total number of Staphylococcus aureus in the 2A-30 s treatment group increased by 0.41 log CFU/g. The total number of Staphylococcus aureus in the 2A-300 s treatment group increased by 1.13 log CFU/g. The total number of Staphylococcus aureus in the 6A-30 s treatment group increased by 0.41 log CFU/g. The total number of Staphylococcus aureus in the 6A-300 s treatment group decreased by 0.04 log CFU/g. During this period, almost all treatment groups showed a roughly unchanged and upward trend, the 2A-30 s treatment group had the largest increase, but the total number was still the smallest among all the groups, while the CK group still had the largest total number of Staphylococcus aureus.

From the day of treatment till the end of storage, the total number of Staphylococcus aureus in the CK group increased by 1.23 log CFU/g. The total number of Staphylococcus aureus in the 2A-30 s treatment group increased by 0.11 log CFU/g. The total number of Staphylococcus aureus in the 2A-300 s treatment group increased by 1.13 log CFU/g. The total number of Staphylococcus aureus in the 6A-30 s treatment group increased by 0.21 log CFU/g. The total number of Staphylococcus aureus in the 6A-300 s treatment group decreased by 0.62 log CFU/g. The total number of Staphylococcus aureus in the plasma treatment groups was less than that in the CK group, and there were significant differences. No matter on day 0, day 2 or day 4, the 2A-300 s treatment group had the optimal inhibitory effect on Staphylococcus aureus.

### 8) Determination of Total Number of Bacillus Cereus Colonies

0.1 mL of the sample dilution was pipetted onto the MEYP agar medium, spread evenly on the MEYP plate with a disposable coating rod, and put in a 37° C. biochemical incubator for culture for 24-48 h to determine the total number of Bacillus cereus colonies. The detection was conducted once every 48 h. The results are shown in Table 5 and FIG. 11. FIG. 11 shows changes in the total number of Bacillus cereus in the mulberry fruits during storage.

TABLE 5

Impact of atmospheric plasma treatment on total number of Bacillus cereus in mulberry fruits during storage at 20° C.

| | | | |
|---|---|---|---|
| Treatment | 0 d | 2 d | 4 d |
| CK | 3.48±0.17a | 3.98±0.19a | 4.41±0.18a |
| 2A-30 s | 2.11±0.26c | 1.33±0.27d | 3.63±0.26c |
| 2A-300 s | 0.00±0.00d | 0.00±0.00e | 3.27±0.24d |
| 6A-30 s | 2.53±0.19b | 3.29±0.24b | 3.97±0.13b |
| 6A-300 s | 2.43±0.22b | 2.35±0.19c | 3.55±0.28c |

Note: Different letters after values in the same column in the table indicate significant differences, p<0.05

It can be seen from Table 5 that on the day of treatment, the total number of Bacillus cereus in the atmospheric plasma treatment groups was significantly less than that in the CK group. The 2A-30 s, 2A-300 s, 6A-30 s, and 6A-300 s atmospheric plasma treatment groups could inhibit 1.37 log CFU/g, 3.48 log CFU/g, 0.95 log CFU/g, and 1.05 log CFU/g of Bacillus cereus respectively.

On the 2^{nd} day of storage at 20° C. after treatment, the total number of Bacillus cereus in the atmospheric plasma treatment groups was significantly less than that in the CK group. The 2A-30 s, 2A-300 s, 6A-30 s, and 6A-300 s atmospheric plasma treatment groups could inhibit 2.65 log CFU/g, 3.98 log CFU/g, 0.69 log CFU/g, and 1.63 log CFU/g of Bacillus cereus respectively.

On the 4^{th} day of storage at 20° C. after treatment, the total number of Bacillus cereus in the atmospheric plasma treatment groups was significantly less than that in the CK group, and there were significant differences. The 2A-30 s, 2A-300 s, 6A-30 s, and 6A-300 s atmospheric plasma could inhibit 0.78 log CFU/g, 1.14 log CFU/g, 0.44 log CFU/g, and 0.86 log CFU/g of Bacillus cereus respectively.

It can be seen from FIG. 11 that during storage from day 0 to day 2, the total number of Bacillus cereus in the CK group increased by 0.50 log CFU/g. The total number of Bacillus cereus in the 2A-30 s treatment group decreased by 0.78 log CFU/g. There was no change in the 2A-300 s treatment group, both below a detection level. The total number of Bacillus cereus in the 6A-30 s treatment group increased by 0.76 log CFU/g. The total number of Bacillus cereus in the 6A-300 s treatment group decreased by 0.08 log CFU/g. The total number of Bacillus cereus in the 6A-30 s group had the largest increase. The total number of Bacillus cereus in the 2A-30 s treatment group did not increase but decreased. There was no significant change in the total number of Bacillus cereus in the 6A-300 s and 2A-300 s treatment groups. At the storage point on day 2, the CK group still had the largest total number of Bacillus cereus. It is showed that atmospheric plasma had an antibacterial effect during this storage period, and could inhibit the increase of the total number of Bacillus cereus.

During storage from day 2 to day 4, the total number of Bacillus cereus in all the groups increased significantly. The total number of Bacillus cereus in the CK group increased by 0.43 log CFU/g. The total number of Bacillus cereus in the 2A-30 s treatment group increased by 2.30 log CFU/g. The total number of Bacillus cereus in the 2A-300 s treatment group increased by 3.27 log CFU/g. The total number of Bacillus cereus in the 6A-30 s treatment group increased by 0.68 log CFU/g. The total number of Bacillus cereus in the 6A-300 s treatment group decreased by 1.20 log CFU/g. The total number of Bacillus cereus in all the groups increased. The plasma treatment groups had a larger increase during this period, while the CK group still had the largest total number of Bacillus cereus.

From the day of treatment till the end of storage, the total number of Bacillus cereus in the CK group increased by 0.93 log CFU/g. The total number of Bacillus cereus in the 2A-30 s treatment group increased by 1.52 log CFU/g. The total number of Bacillus cereus in the 2A-300 s treatment group increased by 3.27 log CFU/g. The total number of Bacillus cereus in the 6A-30 s treatment group increased by 1.44 log CFU/g. The total number of Bacillus cereus in the 6A-300 s treatment group decreased by 1.12 log CFU/g. The total number of Bacillus cereus in the plasma treatment groups was less than that in the CK group, and there were significant differences. No matter on day 0, day 2 or day 4, the 2A-300 s treatment group had the optimal inhibitory effect on Bacillus cereus.

### Example 2 Antibacterial Effect of Atmospheric Plasma on Salmonella and Botrytis Cinerea

### 1. Materials

1) A Salmonella strain is a common Salmonella serotype, Salmonella typhimurium, provided by the Laboratory of the Institute of Preventive Veterinary Medicine, College of Animal Sciences, Zhejiang University.

2) The tested freeze-dried powder strain Botrytis cinerea ATCC32762 was purchased from Shanghai Bioresource Collection Center.

3) Mulberry fruits were picked from the mulberry resources nursery of the Zijingang campus of Zhejiang University. The variety was Big 10 (or called Big Ten, Seedless Big Ten, and Seedless Big 10).

### 4) Preparation of Main Media and Reagents

A brain heart infusion broth was purchased from Beijing Land Bridge Biotechnology Co., Ltd. 52 g of powder was weighed with an accurate electronic balance and placed into a conical flask, 1,000 mL of distilled water was added, heated and stirred to dissolve, sterilized under high pressure at 121° C. for 15 min, cooled naturally, and stored at 4° C. for later use.

A tryptone soy broth was purchased from Qingdao Hope Bio-Technology Co., Ltd. 30 g of powder of the tryptone soy broth was weighed with an accurate electronic balance and placed into a conical flask, 1,000 mL of distilled water was added, heated and stirred to dissolve, sterilized under high pressure at 121° C. for 15 min, cooled naturally, and stored at 4° C. for later use.

Analytically pure sodium hypochlorite (NaClO) with 4% available chlorine was diluted with sterile distilled water to prepare a sodium hypochlorite solution with a concentration of 200 ppm, and stored in a cool and dark place for later use.

Reference can be made to the above solutions for specific preparation methods of a xylose lysine sodium deoxycholate medium, a PDA medium, a buffered peptone water medium, and analytically pure sodium chloride (NaCl).

### 2. Method

### 1) Determination of Standard Curve of Salmonella

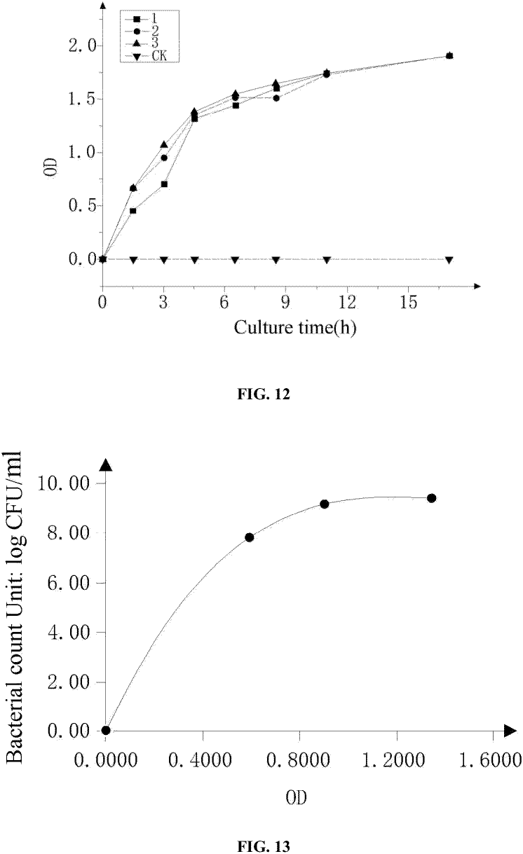

The growth standard curve graph of Salmonella was determined by using the OD standard curve method. Stock Salmonella cultures were stored at -80° C. with 50% glycerol. 0.2 mL of Salmonella stock was aspirated with a pipette. A nutrient agar plate was streaked with a plate streak method. Then the stock was put in a 37° C. biochemical incubator for culture for 24-48 h to separate pure colonies. Well-grown colonies on the plate were selected. 10 mL of sterilized tryptone soy broth was inoculated with the well-grown colonies for the second culture, and put on a 37° C. constant temperature shaker for shaking culture. During culture, at regular intervals, the Salmonella culture solution was taken and put into a 4° C. refrigerated high-speed centrifuge for centrifugation for 15 min, filtered to remove the upper culture solution, sterile saline was added to prepare a Salmonella suspension. Centrifugation was conducted again for 15 min to remove residual culture solution. Using a UV-Vis spectrophotometer, the OD of the Salmonella suspension corresponding to this time point was measured at 620 nm, and the Salmonella suspension was serially diluted at the same time. The specific colony number was measured by the plate coating method, so as to establish the OD-culture time standard curve and OD-bacterial count standard curve of Salmonella, and the whole experiment was repeated three times. The results are shown in FIG. 12. FIG. 12 shows an OD-culture time standard curve of Salmonella.

### 2) Culture of Salmonella

Salmonella cultures were stored at -80° C. with 50% glycerol. 0.2 mL of Salmonella bacteria solution was aspirated with a pipette. A nutrient agar plate was streaked with a plate streak method. Then the bacteria solution was put in a 37° C. biochemical incubator for culture for 24-48 h to separate pure colonies. Well-grown colonies on the plate were selected. 10 mL of sterilized tryptone soy broth was inoculated with the well-grown colonies, and put on a 37° C. constant temperature shaker to be shaken for the second culture.

According to the measured OD-bacterial count standard curve in step 1), the OD range required for an inoculum amount of about 8 log CFU/g bacterial suspension and the approximately required culture time were determined. When the time was close to the required time, the OD range of the bacterial suspension was determined. If the log value was met with reference to the standard curve, that was, 4° C. for later use, and the experiment was repeated three times.

In the early stage of culture of Salmonella, the OD of Salmonella gradually increased with time. In the later stage of culture, the growth rate of the OD of Salmonella gradually slowed down. It indicated the growth characteristics of Salmonella. In the early stage of culture, Salmonella was in the rapid growth period, and in the later stage of culture, Salmonella entered the growth plateau stage. Taking the OD of the Salmonella bacterial suspension as the independent variable, and taking the logarithmic value of the bacterial count obtained by the Salmonella count as the dependent variable, the OD-bacterial count standard curve of Salmonella was drawn (FIG. 13). It can be seen that the exponential equation for the OD of Salmonella is y=-7.7243×²+17.324x-0.0008. The coefficient of determination R²=0.9984, and s value is 0.0900. The fitting degree is good, and it can be used to quantitatively calculate the bacterial count of Salmonella.

### 3) Preparation of Botrytis Cinerea Spore Suspension

The tested strain Botrytis cinerea freeze-dried powder ATCC32762 was transferred to the PDA medium for culture after two activations, and after 10 days, the culture surface was impregnated with sterile distilled water to obtain fungal spores. To remove unnecessary hyphae, the spore suspension was filtered through a double layer of sterile gauze. The spore concentration of the suspension was then measured by observation with a hemocytometer under a microscope. The concentration of spores prepared in this experiment was about 10⁶/mL.

### 4) Preparation of Mulberry Fruits

Intact mulberry fruits with uniform size, consistent color and maturity, and no mechanical damage were selected. The fresh mulberry fruits had a weight controlled at 5.0±0.50 g/piece for later use. The selected mulberry fruits were soaked in 200 ppm sodium hypochlorite (NaClO) for 2 min to remove the native natural flora on the surface. The mulberry fruits were put in a biological safety cabinet to dry for 30 min. When drying for 15 min, the mulberry fruits were turned over to ensure that each side of the mulberry fruit could be completely dried. The methods for preparation of the mulberry fruits for Salmonella and Botrytis cinerea are the same.

### 5) Mulberry Fruit Strain Inoculation

### Inoculation of Salmonella

By the point connection method, 10 µL of cultured Salmonella bacteria solution was aspirated with a pipette and the surface of the mulberry fruits was inoculated with the bacteria solution. Then drying was conducted in a biological safety cabinet for 30 min. After the inoculated Salmonella was fixed and attached to the surface of the mulberry fruits, plasma treatment was conducted.

### Inoculation of Botrytis Cinerea

The inoculation method of Botrytis cinerea was the same as that of Salmonella, and the Botrytis cinerea spore suspension was inoculated by the point connection method.

### 6) Atmospheric Plasma Treatment

### Treatment of Salmonella in Mulberry Fruits by Atmospheric Plasma

A total of 4 experimental groups and 1 CK group were set in the Salmonella parameter experiment. The group without treatment after inoculation was used as the CK group, and the atmospheric plasma treatment group was used as the experimental group and the control group. The experimental group was treated with a current of 2 A for 300 s, and the control group was treated with a current of 6 A for 30 s. Three duplicates were set for each group, and the experiment was repeated twice.

After that, based on the treatment with the current of 2A for 300 s, the impacts of different plasma temperatures and different storage temperatures during storage on the sterilization effect of Salmonella on the surface of the mulberry fruits were compared. A total of 4 experimental groups and 2 CK groups were set. The different plasma temperatures were divided into two levels, one was naturally generated atmospheric plasma, that is, atmospheric room-temperature plasma at 22° C., and the other was low-temperature plasma at 9° C. after physical cooling of natural atmospheric plasma. The physical cooling method used was to pre-cool a plasma transfer tube in ice for 3 h in advance. Two levels were set for the different storage temperatures, namely simulating daily indoor storage and low-temperature storage, and the temperature was divided into 20° C. and 4° C.

### Treatment of Botrytis Cinerea in Mulberry Fruits by Atmospheric Plasma

4 experimental groups and 1 CK group were used, and reference may be made to step (1) for details. After grouping, the mulberry fruits were aseptically transferred to a sterilized airtight container, laid in a single layer, and placed evenly. An air tube was connected to the air outlet of the atmospheric plasma reactor for atmospheric plasma treatment. The other end is an air outlet. According to different groups, corresponding plasma parameters were adjusted for treatment. After treatment, the inlet and outlet of the airtight container were sealed with sealing film layer by layer.

### 7) Salmonella Count

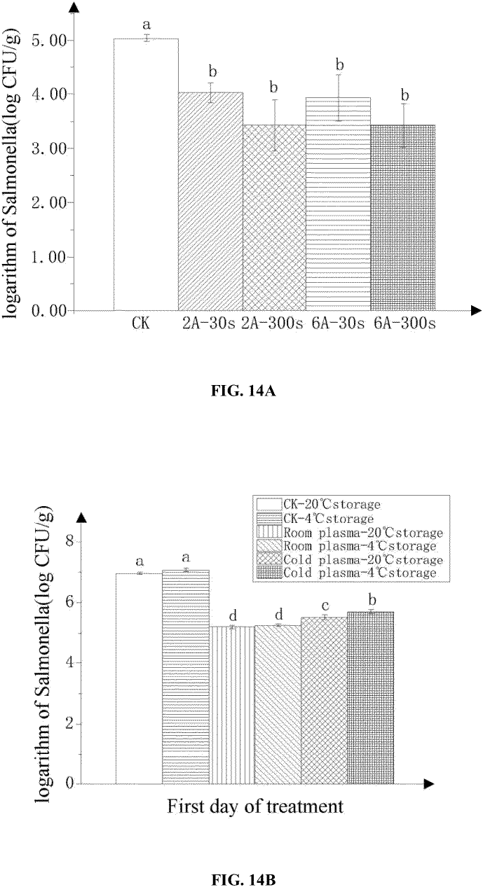

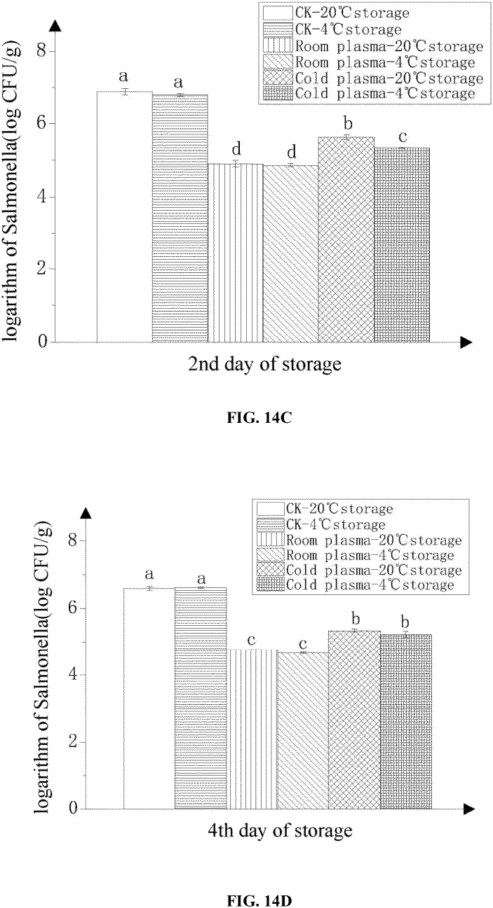

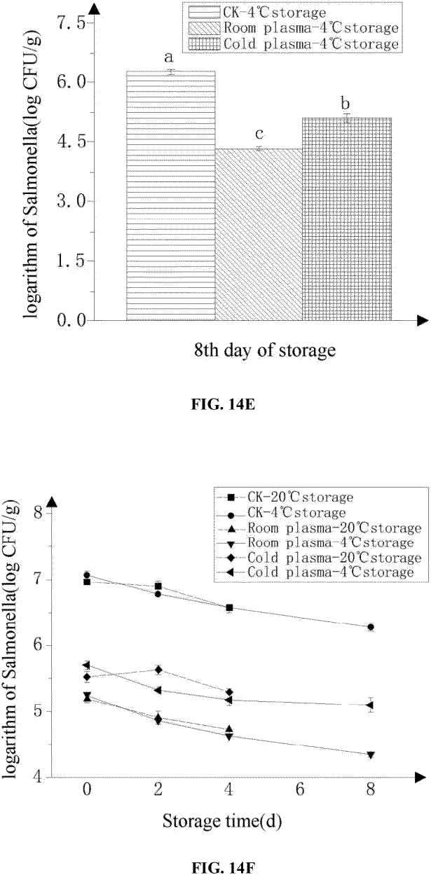

The mulberry fruits were put in about 30 mL of buffered peptone water, and the remaining Salmonella on the mulberry fruits were eluted with a shaker at 180 rpm for 2 min. The resulting homogenate was diluted with 0.1% PW, coated on xylose lysine desoxycholate medium using the plate coating method, and cultured at 37° C. for 24 h for counting, and the experiment was repeated three times. The measurement results are shown in Table 6 and FIG. 14A to FIG. 14F. FIG. 14A shows the number of colonies of Salmonella in the mulberry fruits generated by different parameter settings after atmospheric plasma treatment. FIG. 14B shows the number of colonies of Salmonella in the mulberry fruits on the day of treatment. FIG. 14C shows the number of colonies of Salmonella in the mulberry fruits on the 2^{nd} day of storage. FIG. 14D shows the number of colonies of Salmonella in the mulberry fruits on the 4^{th} day of storage. FIG. 14E shows the number of colonies of Salmonella in the mulberry fruits on the 8^{th} day of storage. FIG. 14F shows colony changes of Salmonella in the mulberry fruits after atmospheric plasma treatment under different conditions during storage.

TABLE 6

Total number of Salmonella in mulberry fruits after atmospheric plasma treatment

| | |
|---|---|
| Treatment | Total number of Salmonella |
| CK | 5.04±0.06a |
| 2A-30 s | 4.03±0.19b |
| 2A-300 s | 3.42±0.47b |
| 6A-30 s | 3.93±0.43b |
| 6A-300 s | 3.42±0.40b |

In FIG. 14B to FIG. 14F, CK-20° C. storage indicates that the CK group is stored at a room temperature of 20° C. CK-4° C. storage indicates that the CK group is stored at a low temperature of 4° C. Room plasma-20° C. storage refers to storage at a room temperature of 20° C. after atmospheric plasma treatment at a room temperature of 22° C. Room plasma-4° C. storage refers to storage at a low temperature of 4° C. after atmospheric plasma treatment at a room temperature of 22° C. Cold plasma-20° C. storage refers to storage at a room temperature of 20° C. after atmospheric plasma treatment at a low temperature of 9° C. Cold plasma-4° C. storage refers to storage at a low temperature of 4° C. after atmospheric plasma treatment at a low temperature of 9° C.

It can be seen from Table 6 and FIG. 14A that after the atmospheric low-temperature plasma treatment, the number of colonies of Salmonella decreased significantly, and there was a significant difference. Compared with the untreated group, all the atmospheric low-temperature plasma treatment groups could significantly inhibit Salmonella, and the atmospheric plasma treatment groups of 2A-30 s, 2A-300 s, 6A-30 s, and 6A-300 s could inhibit 1.01 log CFU/g, 1.62 log CFU/g, 1.11 log CFU/g, and 1.62 log CFU/g respectively. Analysis of the experimental results shows that atmospheric plasma treatment has a significant sterilization effect on Salmonella on the surface of the mulberry fruits. The antibacterial effect on Salmonella became more obvious with extension of the treatment time, and the plasma treatment for 300 s was more excellent than that for 30 s. The plasma current did not show a clear effect on Salmonella. There was no significant difference between the treatments with 2A and 6A. The 2A-300 s treatment group had the optimal result.

It can be seen from FIG. 14B that on the day of treatment, compared with CK-20° C. storage, room plasma-20° C. storage could inhibit 1.77 log CFU/g, and cold plasma-20° C. storage could inhibit 1.44 log CFU/g. Compared with CK-4° C. storage, room plasma-4° C. storage could inhibit 1.83 log CFU/g, and cold plasma-4° C. storage could inhibit 1.37 log CFU/g. On the day of treatment, all plasma treatment groups could significantly reduce the number of colonies of Salmonella. Room plasma-4° C. storage had the optimal treatment result, which could reduce up to 1.83 log CFU/g, and cold plasma-20° C. storage had the worst treatment result, which could reduce up to 1.44 log CFU/g, and the difference in antibacterial effect between the two was 0.39 log CFU/g.

It can be seen from FIG. 14C that on the 2^{nd} day of storage, compared with CK-20° C. storage, room plasma-20° C. storage could inhibit 1.98 log CFU/g, and cold plasma-20° C. storage could inhibit 1.26 log CFU/g. Compared with CK-4° C. storage, room plasma-4° C. storage could inhibit 1.92 log CFU/g, and cold plasma-4° C. storage could inhibit 1.56 log CFU/g. It can be seen from FIGS. 3-5 that on the 2^{nd} day of storage, all plasma treatment groups could significantly reduce the number of colonies of Salmonella. Room plasma-20° C. storage had the optimal treatment result, which could reduce up to 1.98 log CFU/g, and cold plasma-20° C. storage had the worst treatment result, which could reduce up to 1.26 log CFU/g, and the difference in antibacterial effect between the two was 0.72 log CFU/g.

It can be seen from FIG. 14D that on the 4^{th} day of storage, compared with CK-20° C. storage, room plasma-20° C. storage could inhibit 1.83 log CFU/g, and cold plasma-20° C. storage could inhibit 1.27 log CFU/g. Compared with CK-4° C. storage, room plasma-4° C. storage could inhibit 1.95 log CFU/g, and cold plasma-4° C. storage could inhibit 1.38 log CFU/g. On the 4^{th} day of storage, all plasma treatment groups could significantly reduce the number of colonies of Salmonella. Room plasma-4° C. storage had the optimal treatment result, which could reduce up to 1.95 log CFU/g, and cold plasma-20° C. storage had the worst treatment result, which could reduce up to 1.27 log CFU/g. The difference in antibacterial effect between the two was 0.68 log CFU/g.

It can be seen from FIG. 14E that on the 8^{th} day of storage, the mulberry fruits stored at 20° C. had rotted, and were not detected, and only Salmonella on the surface of the mulberry fruits stored at 4° C. was detected. Compared with CK-4° C. storage, room plasma-4° C. storage could inhibit 1.94 log CFU/g, and cold plasma-4° C. storage could inhibit 1.18 log CFU/g. On the 8^{th} day of storage, all plasma treatment groups could significantly reduce the number of colonies of Salmonella. Room plasma-4° C. storage had the optimal treatment result. Cold plasma-4° C. storage had the worst treatment result. The difference in antibacterial effect between the two was 0.76 log CFU/g.

It can be seen from FIG. 14F that during storage from day 0 to day 2, the number of colonies in CK-20° C. storage decreased by 0.07 log CFU/g. The number of colonies in CK-4° C. storage decreased by 0.28 log CFU/g. The number of colonies in room plasma-20° C. storage decreased by 0.28 log CFU/g. The number of colonies in room plasma-4° C. storage decreased by 0.38 log CFU/g. The number of colonies in cold plasma-20° C. storage increased by 0.11 log CFU/g. The number of colonies in cold plasma-4° C. storage decreased by 0.37 log CFU/g. During this storage period, room plasma-4° C. storage had the optimal result, which could further reduce Salmonella by 0.38+0.08 log CFU/g.

During storage from day 2 to day 4, the number of colonies in CK-20° C. storage decreased by 0.33 log CFU/g. The number of colonies in CK-4° C. storage decreased by 0.20 log CFU/g. The number of colonies in room plasma-20° C. storage decreased by 0.18 log CFU/g. The number of colonies in room plasma-4° C. storage decreased by 0.23 log CFU/g. The number of colonies in cold plasma-20° C. storage decreased by 0.34 log CFU/g. The number of colonies in cold plasma-4° C. storage decreased by 0.15 log CFU/g. During this storage period, room plasma-4° C. storage had the optimal result, which could further reduce Salmonella by 0.34 log CFU/g.

During storage from day 4 to day 8, the number of colonies in CK-4° C. storage decreased by 0.30 log CFU/g. The number of colonies in room plasma-4° C. storage decreased by 0.29 log CFU/g. The number of colonies in cold plasma-4° C. storage decreased by 0.08 log CFU/g. During this storage period, room plasma-4° C. storage had the optimal result. The experimental results throughout the storage period showed that compared with the untreated CK group, all the atmospheric plasma treatment groups could significantly inhibit the growth of Salmonella. During storage, long-lived particles in the atmospheric plasma continued to act, so both the atmospheric room-temperature plasma and the low-temperature plasma could continue to kill Salmonella, and the sterilization effect of the plasma continued. In terms of action effect, the atmospheric room-temperature plasma had a more excellent sterilization effect than the atmospheric low-temperature plasma.

### 8) Mildew Incidence Statistics

A total of 150 mulberry fruits in each group were used to count the mildew incidence, 50 of which were grouped as one sample, and there were 3 biological duplicates. Surface mildew was counted every 2 days. The appearance of gray mold spots on the surface of the mulberry fruits was identified as mildew. Fruit mildew incidence = number of mildew/total number of fruits. Reference may be made to Table 7 for results.

TABLE 7

Mildew incidence of mulberry fruits inoculated with Botrytis cinerea after atmospheric plasma treatment

| | | | |
|---|---|---|---|
| Treatment | 0 d | 2 d | 4 d |
| CK | 0.00%±0.00a | 78.67%±0.28a | 88.00%±0.01a |
| 2A-30 s | 0.00%±0.00a | 24.67%±0.17b | 60.67%±0.03b |
| 2A-300 s | 0.00%±0.00a | 10.00%±0.08c | 26.67%±0.01d |
| 6A-30 s | 0.00%±0.00a | 15.33%±0.10c | 36.67%±0.04c |
| 6A-300 s | 0.00%±0.00a | 14.00%±0.08c | 30.00%±0.02c |

Note: Different letters after values in the same column indicate significant differences (p<0.05)

It can be seen from Table 7 that after storage for 2 days, the 2A-30 s plasma treatment group could reduce the mildew by 54.00%. The 2A-300 s plasma treatment group could reduce the mildew by 68.67%. The 6A-30 s plasma treatment group could reduce the mildew by 63.34%. The 6A-300 s plasma treatment group could reduce the mildew by 64.67%. 2 days after treatment, the group with treatment of the mulberry fruits with the atmospheric low-temperature plasma generated by the instrument running at 2A current for 300 s had the optimal storage effect, which could reduce mildew by up to 68.67%.

4 days after treatment, the 2A-30 s plasma treatment group could reduce the mildew by 27.33%. The 2A-300 s plasma treatment group could reduce the mildew by 61.33%. The 6A-30 s plasma treatment group could reduce the mildew by 51.33%. The 6A-300 s plasma treatment group could reduce the mildew by 58.00%. 4 days after treatment, the group with treatment of the mulberry fruits with the atmospheric low-temperature plasma generated by the instrument running at 2A current for 300 s had the optimal storage effect, which could reduce the mildew incidence by up to 61.33%.

During storage from day 0 to day 2, the mildew incidence of all treatment groups increased, among which the mildew incidence of the control group increased the most, from 0 to 78.67%, while the mildew incidence of the plasma treatment group increased in the range from 10.00% to 24.67%, and the 2A-300 s treatment group increased the least.

During storage from day 2 to day 4, the mildew incidence of all treatment groups also increased, among which the plasma treatment groups had a larger increase, especially the 2A-30 s treatment group increased the mildew incidence by 36.00%, with the largest increase. The 2A-300 s treatment group in the plasma treatment groups had the smallest increase in the mildew incidence, which increased the mildew incidence by 16.67%, while the mildew incidence in the CK treatment group increased by only 9.33%. Although the CK treatment group had the smallest increase in the mildew incidence at this stage, its proportion of mildew was the largest, because at the beginning of this storage period, the good fruit rate of CK was 21.33%, and the increased mildew incidence of 9.33% accounted for 43.74% of all good fruit rates. Throughout the storage period, the atmospheric low-temperature plasma could significantly inhibit the growth of Botrytis cinerea on the surface of the mulberry fruits.

### Example 3 Impact of Atmospheric Plasma on Postharvest Quality of Mulberry Fruits

### 1. Materials

The mulberry fruits were picked from the mulberry resources nursery of the Zijingang campus of Zhejiang University in May 2019. The purchasing temperature was around 28° C. The variety was Big 10 (or called Big Ten, Seedless Big Ten, and Seedless Big 10). The mulberry fruits were directly transported back to the cold storage for treatment.

### 2. Method

### 1) Preparation of Mulberry Fruits

Intact mulberry fruits with uniform size, consistent color and maturity, and no mechanical damage were selected, and put in a sample treatment box for plasma treatment.

### 2) Atmospheric Plasma Treatment

1 CK group and 4 atmospheric plasma treatment groups were set. Two levels of the current were 2A and 6A respectively, and two levels of the treatment time were 30 s and 300 s respectively. It mainly included the following groups: 1) CK; 2) 2A-30 s; 3) 2A-300 s; 4) 6A-30 s; and 5) 2A-300 s. 5 mulberry fruits were required for each sample, and three duplicates were set.

### 3) Mulberry Fruit Storage

After plasma treatment, the mulberry fruits were put in a constant temperature intelligent cold storage for storage at 20° C. and 90% humidity. The quality was measured on the day of treatment and the 2^{nd} and 4^{th} day of storage.

### 4) Determination of Color of Mulberry Fruits

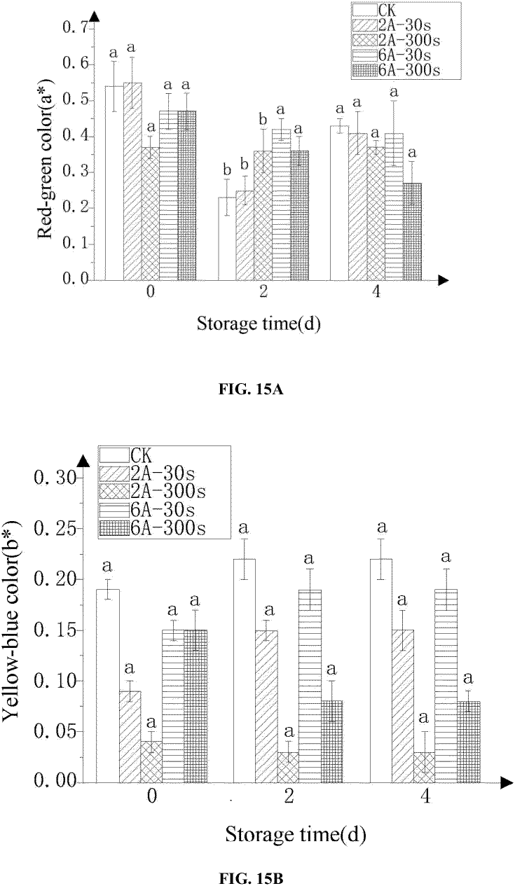

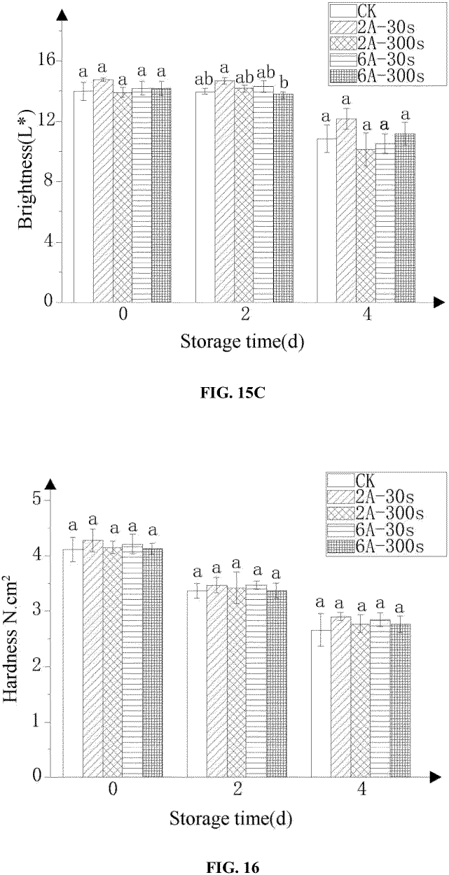

According to the CIELab color system, the color of the mulberry fruits was measured and analyzed, and checked using a white board before use. 15 mulberry fruits without rot, or lesions and uniform size were randomly selected from each treatment group, and the color was measured using a colorimeter. The equator of the fruit was aligned with the colorimeter for coloring. The brightness (L*), red-green color (a*), and yellow-blue color (b*) of the mulberry fruits in the color measurement system were recorded, and an average value was taken. The measurement results are shown in Table 8, Table 9, and Table 10, and FIG. 15A, FIG. 15B, and FIG. 15C. FIG. 15A shows red-green colors (a*) of the mulberry fruits after atmospheric plasma treatment under different conditions. FIG. 15B shows yellow-blue colors (b*) of the mulberry fruits after atmospheric plasma treatment under different conditions. FIG. 15C shows brightness (L*) of the mulberry fruits after atmospheric plasma treatment under different conditions. It can be seen from the measurement results of FIG. 15A, FIG. 15B, and FIG. 15C that there was no significant difference between different atmospheric low-temperature plasma treatments and the CK group, and it can be seen that atmospheric plasma treatment had no significant impact on the color change of the mulberry fruits (p<0.05).

TABLE 7

8 Brightness (L*) of mulberry fruits after atmospheric plasma treatment under different conditions

| | | | |
|---|---|---|---|
| Treatment | 0 d | 2 d | 4 d |
| CK | 13.98±0.61a | 13.95±0.20ab | 10.85±0.90a |
| 2A-30 s | 14.75±0.13a | 14.66±0.20a | 12.14±0.70a |
| 2A-300 s | 13.89±0.32a | 14.16±0.24ab | 10.13±1.09a |
| 6A-30 s | 14.16±0.45a | 14.30±0.40ab | 10.51±0.64a |
| 6A-300 s | 14.16±0.45a | 13.75±0.19b | 11.24±0.76a |

Note: Different letters after values in the same column in the table indicate significant differences, p<0.05

It can be seen from the results in Table 8 that there was no significant change in L* in all the groups during storage from day 0 to day 2, and L* in all the groups decreased during storage from day 2 to day 4. On the 2^{nd} day of storage, L* in the 2A-30 s treatment group was significantly greater than that in the 6A-300 s treatment group, but there was no significant difference between all plasma treatment groups and the CK group. The results of L* showed that atmospheric plasma treatment had no significant impact on the color of the mulberry fruits, and short-time treatment was more conducive to maintaining the color of the mulberry fruits.

TABLE 9

Red-green color (a*) of mulberry fruits after atmospheric plasma treatment under different conditions

| | | | |
|---|---|---|---|
| CK | 0.54±0.07a | 0.23±0.05b | 0.43±0.02a |
| 2A-30 s | 0.55±0.07a | 0.25±0.04b | 0.41±0.06a |
| 2A-300 s | 0.37±0.03a | 0.36±0.06b | 0.37±0.02a |
| 6A-30 s | 0.47±0.05a | 0.42±0.03a | 0.41±0.09a |
| 6A-300 s | 0.47±0.05a | 0.36±0.04a | 0.27±0.06a |

Note: Different letters after values in the same column in the table indicate significant differences, p<0.05

It can be seen from the results in Table 9 that during storage, a* in the CK and 2A-30 s treatment groups first increased and then remained unchanged. a* of the mulberry fruits in the 2A-300 s treatment group basically did not change. a* of the mulberry fruits in the 6A-300 s and 6A-300 s treatment groups decreased gradually and slowly. At each storage time point, there was no significant difference in a* of the mulberry fruits in all the groups.

TABLE 10

Yellow-blue color (b*) of mulberry fruits after atmospheric plasma treatment under different conditions

| | | | |
|---|---|---|---|
| Treatment | 0 d | 2 d | 4 d |
| CK | 1.19±0.01a | 0.22±0.02a | 0.22±0.02a |
| 2A-30 s | 0.09±0.01a | 0.15±0.01a | 0.15+0.02a |
| 2A-300 s | 0.04±0.01a | 0.03±0.01a | 0.03±0.02a |
| 6A-30 s | 0.15±0.01a | 0.19±0.02a | 0.19±0.02a |
| 6A-300 s | 0.15±0.02a | 0.08±0.02a | 0.08±0.01a |

Note: Different letters after values in the same column in the table indicate significant differences, p<0.05

It can be seen from the results in Table 10 that during storage, b* in the CK, 2A-30 s, and 6A-300 s treatment groups first increased and then remained unchanged. b* of the mulberry fruits in the 2A-300 s treatment group basically did not change. b* of the mulberry fruits in the 6A-300 s treatment group decreased gradually and slowly. At each storage time point, there was no significant difference in b* of the mulberry fruits in all the groups.

### 5) Determination of Hardness of Mulberry Fruits

The hardness of the mulberry fruits was measured by a texture analyzer. A probe with a diameter of 5.0 mm was selected, a falling depth of the probe was set to 5.0 mm, and a pressing rate of the probe was set to 1 mm/s. The hardness was measured in the equatorial region of the mulberry fruits. 15 mulberry fruits were randomly selected for hardness measurement in each treatment, and the results were averaged in N.cm⁻². The results are shown in FIG. 11 and FIG. 16. FIG. 16 shows the hardness of the mulberry fruits after atmospheric plasma treatment under different conditions.

Hardness was one of the most common physical parameters used to evaluate fruit quality, and the hardness of the mulberry fruit directly reflects its quality. It can be seen from Table 11 that on the day of treatment, the hardness of the mulberry fruit ranged from 4.10 to 4.27 N.cm⁻². It can be seen from FIG. 15 that the hardness in the CK group was the lowest, and the hardness in other plasma treatment groups was higher than that in the CK group. The hardness in the 2A-30 s and 6A-30 s plasma treatment groups was higher than that in the 2A-300 s and 6A-300 s plasma treatment groups. There was no significant difference between all groups.

TABLE 11

Hardness of mulberry fruits after atmospheric plasma treatment under different conditions

| | | | |
|---|---|---|---|
| Treatment | 0 d | 2 d | 4 d |
| CK | 4.10±0.22a | 3.36±0.13a | 2.65±0.28a |
| 2A-30 s | 4.27±0.20a | 3.46±0.13a | 2.90±0.06a |
| 2A-300 s | 4.15±0.11a | 3.41±0.27a | 2.76±0.15a |
| 6A-30 s | 4.21±0.17a | 3.47±0.07a | 2.84±0.11a |
| 6A-300 s | 4.12±0.10a | 3.37±0.13a | 2.76±0.14a |

Note: Different letters after values in the same column in the table indicate significant differences, p<0.05

It can be seen from FIG. 16 that on the 2^{nd} day of treatment, the hardness of the mulberry fruit ranged from 3.36 to 3.47 N.cm⁻². During storage from day 0 to day 2, the hardness in all the groups decreased in a range of 0.72-0.81 N.cm⁻². The hardness in the CK group was still the lowest. The hardness in the 2A-30 s and 6A-30 s plasma treatment groups was higher than that in the 2A-300 s and 6A-300 s plasma treatment groups. There was no significant difference between all groups. On the 4^{th} day of treatment, the hardness of the mulberry fruit ranged from 2.65 to 2.90 N.cm⁻². During storage from day 2 to day 4, the hardness in all the groups decreased in a range of 0.56-0.70 N.cm⁻². The hardness in the CK group was still the lowest. There was no significant difference between all groups. Throughout the storage period, with the extension of storage time, the hardness of the mulberry fruits gradually decreased, but there was no significant difference between the treatment group and the control group, that is, atmospheric plasma treatment had no impact on the hardness of the mulberry fruits.

### 6) Determination of pH of Mulberry Fruits

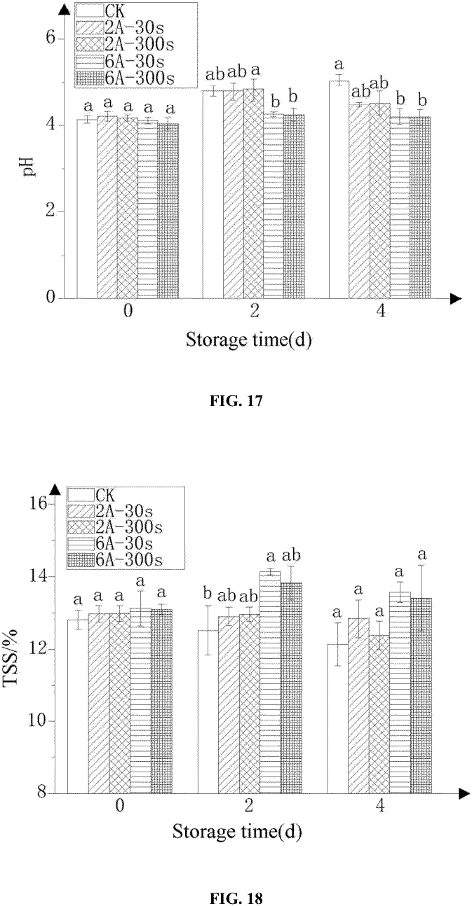

The mulberry fruits were put into a 100-mesh double-sided filter cloth and squeezed manually, and the squeezed fruit juice was measured by a hand-held pH meter. Each treatment was repeated 3 times. The results are shown in Table 12 and FIG. 17. FIG. 17 shows the pH of the mulberry fruits after atmospheric plasma treatment under different conditions.

TABLE 12

pH of mulberry fruits after atmospheric plasma treatment under different conditions

| | | | |
|---|---|---|---|
| Treatment | 0 d | 2 d | 4 d |
| CK | 4.13±0.08a | 4.8±0.12a | 5.04±0.13a |
| 2A-30 s | 4.20±0.11a | 4.79±0.20a | 4.48±0.05a |
| 2A-300 s | 4.16±0.07a | 4.82±0.25a | 4.51±0.28a |
| 6A-30 s | 4.11±0.07a | 4.25±0.05a | 4.19±0.18a |
| 6A-300 s | 4.02±0.14a | 4.24±0.15a | 4.18±0.17a |

Note: Different letters after values in the same column in the table indicate significant differences, p<0.05

The pH indirectly reflects the acidity of the fruit and is an important indicator for the taste of the fruit. It can be seen from the results in Table 12 that on the day of plasma treatment, the mulberry fruits in the plasma treatment group had a pH value similar to that in the CK group, and there was no significant difference in pH between all groups. During storage from day 0 to day 2, the pH in all the groups increased. The 6A-30 s and 6A-300 s plasma treatment groups had the smallest pH increase and the smallest pH. The CK group and the 2A-30 s and 2A-300 s treatment groups had similar pH increase. On the 2^{nd} day of storage, the 6A-30 s and 6A-300 s treatment groups could significantly delay the increase of the pH of the mulberry fruits and slow down the accumulation of sugar in the mulberry fruits compared with other groups. During storage from day 2 to day 4, the pH in the CK group increased, the pH in other plasma treatment groups decreased, and the pH in the 6A-30 s and 6A-300 s plasma treatment groups was significantly less than that in CK. However, there was no significant difference in the pH between the 2A-30 s and 2A-300 s plasma treatment groups and the CK group and the 6A-30 s and 6A-300 s treatment groups.

It can be seen from FIG. 17 that the atmospheric plasma treatment groups under the condition of 2A current had no impact on the pH of the mulberry fruits throughout the storage period, while the atmospheric plasma treatment groups under the condition of 6A current could effectively delay the increase of the pH of the mulberry fruits and slow down the accumulation of the sugar in the mulberry fruits, which is conducive to preservation of the mulberry fruits. It can be seen that the atmospheric low-temperature plasma treatment had no significant impact on the pH of the mulberry fruits.

### 7) Determination of TSS of Mulberry Fruits

The TSS content of the mulberry fruits was measured by a portable digital saccharimeter, and the specific operation method was consistent with determination of the pH. The measurement results are shown in Table 13 and FIG. 18. FIG. 18 shows the TSS of the mulberry fruits after atmospheric plasma treatment under different conditions.

TABLE 13

TSS of mulberry fruits after atmospheric plasma treatment under different conditions

| | | | |
|---|---|---|---|
| Treatment | 0 d | 2 d | 4 d |
| CK | 12.81±0.26a | 12.52±0.68a | 12.13±0.59a |
| 2A-30 s | 12.97±0.23a | 12.90±0.25ab | 12.84±0.52a |
| 2A-300 s | 12.98±0.22a | 12.96±0.20ab | 12.38±0.39a |
| 6A-30 s | 13.12±0.48a | 14.14±0.09a | 13.57±0.29a |
| 6A-300 s | 12.09±0.15a | 13.83±0.47ab | 13.41±0.91a |

Note: Different letters after values in the same column in the table indicate significant differences, p<0.05

The TSS is an important indicator for fruit evaluation, which is proportional to sugar content. It can be seen from the results in Table 13 that on the day of plasma treatment, the mulberry fruits in the plasma treatment group had a TSS content similar to that in the CK group, and there was no significant difference in TSS between all groups. During storage from day 0 to day 2, the TSS in the CK group decreased, and there was almost no change in the TSS in the 2A-30 s and 2A-300 s treatment groups, while the TSS in the 6A-30 s and 6A-300 s treatment groups showed an upward trend. On the 2^{nd} day of storage, the 6A-30 s treatment group had the largest TSS, and there was no significant difference compared with the CK group. Other plasma treatments also had TSS greater than that in the CK group, but there was no significant difference.

It can be seen from FIG. 18 that the atmospheric plasma treatment groups could delay the loss of the TSS content of the mulberry fruits during storage, and the 6A-30 s treatment group could significantly increase the TSS content of the mulberry fruits on the 2^{nd} day of storage. There was no significant difference in TSS between the CK group and other treatment groups. It can be seen that the atmospheric low-temperature plasma treatment had no significant impact on the TSS content of the mulberry fruits.

### 8) Determination of Rotting Incidence of Mulberry Fruits

A total of 150 mulberry fruits in each group were used to measure the rotting incidence, 50 of which were grouped as one sample, and there were 3 biological duplicates. After treatment, the mulberry fruits were stored in a constant temperature intelligent fresh-keeping storehouse with UV sterilization at 20° C. and 90% humidity, and the surface rotting incidence was counted every 2 days. According to grading calculation of the rotting incidence, no rot was grade 0, a rotting incidence less than 25% was grade 1, a rotting incidence of 25%-50% was grade 2, a rotting incidence of 50%-75% was grade 3, and a rotting incidence of 75%-100% was grade 4.

The rotting incidence of the mulberry fruits could be calculated according to the following formula.

Rotting incidence of mulberry fruits=(1*number of rotten mulberry fruits corresponding to grade 1)+(2*number of rotten mulberry fruits corresponding to grade 2)+(3*number of rotten mulberry fruits corresponding to grade 3)+(4*number of rotten mulberry fruits corresponding to grade 4)(/4*total number of fruits).

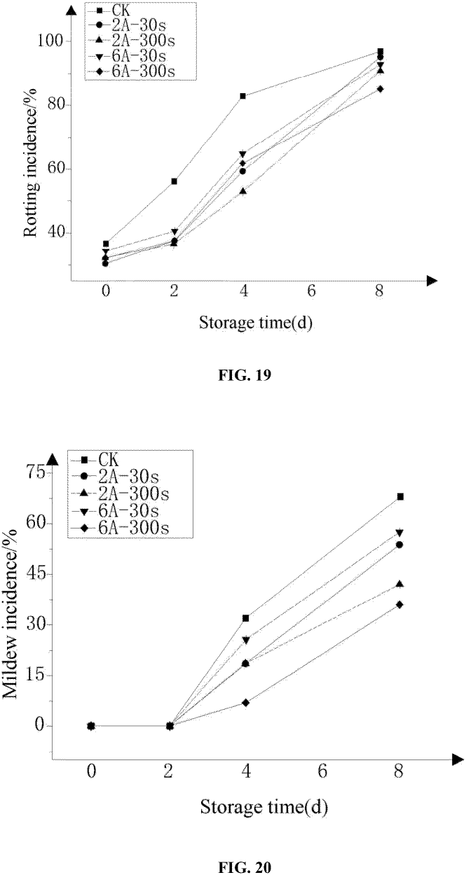

The measurement results are shown in Table 14 and FIG. 19.

TABLE 14

Rotting incidence of mulberry fruits during storage at 20° C. after atmospheric plasma treatment

| | | | | |
|---|---|---|---|---|
| Treatment | 0 d | 2 d | 4 d | 8 d |
| CK | 36.67%±0.02a | 56.22%±0.06a | 82.89%±0.08a | 96.89%±0.02a |
| 2A-30 s | 30.44%±0.00a | 37.56%±0.05b | 59.33%±0.02b | 95.11%±0.02a |
| 2A-300 s | 32.00%±0.03a | 36.67%±0.05b | 52.89%±0.06b | 90.89%±0.01ab |
| 6A-30 s | 34.45%±0.01a | 40.50%±0.04b | 64.93%±0.07ab | 92.94%±0.03ab |
| 6A-300 s | 31.99%±0.01a | 37.67%±0.01b | 61.79%±0.05b | 85.10%±0.04b |

Note: Different letters after values in the same column in the table indicate significant differences (p<0.05)

It can be seen from Table 14 that on the day of treatment, the rotting incidence of all groups was greater than 30.00%, because the rotting incidence was not counted until 6 hours after atmospheric plasma treatment on that day. Compared with the CK group, the atmospheric plasma treatment groups could reduce the rotting incidence to a certain extent, but there was no significant difference, because on the day of treatment, storage had not been conducted, and the rotting incidence had not been affected by the treatment. On the 2^{nd} day of storage, compared with the CK group, the 2A-30 s plasma treatment group could reduce the rotting incidence by 18.66%, and there was a significant difference. The 2A-300 s plasma treatment group could reduce the rotting incidence by 19.55%, and there was a significant difference. The 6A-30 s plasma treatment group could reduce the rotting incidence by 15.72%, and there was no significant difference. The 6A-300 s plasma treatment group could reduce the rotting incidence by 18.55%, and there was a significant difference. On the 4^{th} day of storage, compared with the CK group, the 2A-30 s plasma treatment group could reduce the rotting incidence by 23.56%, and there was a significant difference. The 2A-300 s plasma treatment group could reduce the rotting incidence by 30.00%, and there was a significant difference. The 6A-30 s plasma treatment group could reduce the rotting incidence by 17.96%, and there was a significant difference. The 6A-300 s plasma treatment group could reduce the rotting incidence by 21.10%, and there was a significant difference. On the 8^{th} day of storage, the rotting incidence of the mulberry fruits in all groups reached no less than 85%. Compared with the CK group, the 2A-30 s plasma treatment group could reduce the rotting incidence by 1.78%, and there was no significant difference. The 2A-300 s plasma treatment group could reduce the rotting incidence by 6.00%, and there was no significant difference. The 6A-30 s plasma treatment group could reduce the rotting incidence by 3.95%, and there was no significant difference. The 6A-300 s plasma treatment group could reduce the rotting incidence by 11.79%, and there was a significant difference.

It can be seen from FIG. 19 that the rotting incidence of all treatment groups showed an upward trend throughout the storage period. During storage from day 0 to day 4, the rotting incidence of the CK group increased in the biggest magnitudedegree, and the rotting incidence was the highest. The plasma treatment groups had a similar upward trend with a lower increase. During storage from day 4 to day 8, the rotting incidence of the plasma treatment groups increased greatly, and the difference between the rotting incidence of the plasma treatment group and the CK group was less than that from day 0 to day 4. In summary, atmospheric low-temperature plasma could significantly reduce the rotting incidence of the mulberry fruits during 4 days of storage at 20° C.

### 9) Determination of Mildew Incidence of Mulberry Fruits

A total of 150 mulberry fruits in each group were used to measure the mildew incidence, 50 of which were grouped as one sample, and there were 3 biological duplicates. After treatment, the mulberry fruits were stored in a constant temperature intelligent fresh-keeping storehouse with UV sterilization at 20° C. and 80% humidity, and the surface mildew incidence was counted every 2 days. The appearance of gray mold spots on the surface of the mulberry fruits was identified as mildew, which can be obtained according to the following formula. Fruit mildew incidence = number of mildew/total number of fruits. The measurement results are shown in Table 15 and FIG. 20. FIG. 20 shows the mildew incidence of the mulberry fruits during storage at 20° C. after atmospheric plasma treatment.

TABLE 15

Mildew incidence of mulberry fruits during storage at 20° C. after atmospheric plasma treatment

| | | | | |
|---|---|---|---|---|
| Treatment | 0 d | 2 d | 4 d | 8 d |
| CK | 0.00%±0.00a | 0.00%±0.00a | 32.00%±0.02a | 68.00%±0.02a |
| 2A-30 s | 0.00%±0.00a | 0.00%±0.00a | 18.67%±0.04bc | 54.00%±0.04a |
| 2A-300 s | 0.00%±0.00a | 0.00%±0.00a | 18.67%±0.04bc | 42.00%±0.04bc |
| 6A-30 s | 0.00%±0.00a | 0.00%±0.00a | 25.56%±0.05ab | 57.42%±0.05ab |
| 6A-300 s | 0.00%±0.00a | 0.00%±0.00a | 6.86%±0.03c | 36.02%±0.03c |

Note: Different letters after values in the same column indicate significant differences (p<0.05)

It can be seen from Table 15 that on the day of treatment and the 2^{nd} day of storage, no mildew occurred in all groups, because it takes time for the growth of the mold. After 4 days of storage, compared with the control group, the 2 A-30 s, 2 A-300 s, and 6 A-300 s atmospheric plasma treatment groups significantly reduced the mildew incidence of the mulberry fruits, which was 13.33%, 13.33%, and 25.14% lower than that in the control group respectively. However, the 6 A-30 s plasma treatment had no significant impact on the mildew incidence of the mulberry fruits.

On the 8^{th} day of storage, the mildew incidence of the mulberry fruits in all the groups reached no less than 35.00%. Compared with the control group, the 2 A-300 s and 6 A-300 s atmospheric plasma treatment groups significantly reduced the mildew incidence of the mulberry fruits, which was 26.00% and 31.98% lower than that in the control group respectively. However, the 6 A-30 s plasma treatment had no significant impact on the mildew incidence of the mulberry fruits. It can be seen from FIG. 20 that during storage from day 2 to day 8, the mildew incidence of all treatment groups showed an upward trend. During storage from day 2 to day 4, the mildew incidence of the CK group increased in the biggest magnitude, and the mildew rate was the highest among all groups. During storage from day 4 to day 8, the increasing trend of the mildew incidence in the plasma treatment groups was similar to that in the CK group. At the end of storage, the treatment effect of the 300 s treatment group was more excellent than that of the 30 s treatment group. In summary, atmospheric low-temperature plasma could significantly reduce the mildew incidence of the mulberry fruits during 4 days of storage at 20° C.

The above descriptions are merely preferred implementations of the present disclosure. It should be noted that those of ordinary skill in the art may further make several improvements and modifications without departing from the principle of the present disclosure, and such improvements and modifications should be deemed as falling within the protection scope of the present disclosure.

What is claimed is:

1. A method for sterilizing and preserving fresh mulberry fruits, comprising the following steps:
1) laying the fresh mulberry fruits in a single layer in a hermetic container, wherein the hermetic container is provided with an air inlet; and
2) introducing atmospheric plasma into the hermetic container through the air inlet for sterilization until an air pressure in the hermetic container is 101-102 kPa to obtain sterilized fresh mulberry fruits, wherein the atmospheric plasma has a current of 2-6 A and a temperature of 9-22° C., and the sterilization is conducted for 30-300 s.

2. The method according to claim 1, wherein the atmospheric plasma has a current of 2 A.

3. The method according to claim 1, wherein the atmospheric plasma has an introduction amount of 1-1.1 m³/min.

4. The method according to claim 1, further comprising storing the sterilized fresh mulberry fruits at 1-5° C. after the sterilized fresh mulberry fruits are obtained.

5. The method according to claim 1, wherein the hermetic container has a volume of 8,000-20,000 cm³.

6. The method according to claim 1, wherein the hermetic container has specifications of length × width × height = (40-48) cm × (25-33) cm × (8-12) cm.

7. The method according to claim 1, wherein the hermetic container is further provided with an air outlet.

8. The method according to claim 1, wherein the fresh mulberry fruits are 80% ripe, plump, and purple black.
